(19) United States
(12) Patent Application Publication
(10) Pub. No.: US 2024/0325933 A1
(43) Pub. Date: Oct. 3, 2024

(54) VIRTUAL VEHICLE CONTROL METHOD AND APPARATUS, DEVICE, AND STORAGE MEDIUM

(71) Applicant: Tencent Technology (Shenzhen) Company Limited, Shenzhen (CN)

(72) Inventors: Haosheng XUE, Shenzhen (CN); Jinlong TU, Shenzhen (CN); Zhipeng LUO, Shenzhen (CN)

(21) Appl. No.: 18/741,646

(22) Filed: Jun. 12, 2024

Related U.S. Application Data
(63) Continuation of application No. PCT/CN2023/088581, filed on Apr. 17, 2023.

(30) Foreign Application Priority Data
May 20, 2022 (CN) 202210555869.7

(51) Int. Cl. A63F 13/803; A63F 13/56

(52) U.S. Cl. CPC A63F 13/803; A63F 13/56

(57) ABSTRACT

This application discloses a virtual vehicle control method performed by a computer device. The method includes: displaying a virtual vehicle in a virtual environment; controlling the virtual vehicle to enter a drift state in response to a first steering operation on a direction control component and a brake operation on a handbrake control component; turning the head direction of the virtual vehicle from a first direction to a second direction in response to a second steering operation on the direction control component; and turning the head direction of the virtual vehicle from the second direction to a third direction in response to the brake operation on the handbrake control component. The drift state of the virtual vehicle is maintained through the brake operation so that a capability of the virtual vehicle to pass through a continuous curve is improved.

### CROSS-REFERENCE TO RELATED APPLICATIONS

This application is a continuation application of PCT Patent Application No. PCT/CN2023/088581, entitled “VIRTUAL VEHICLE CONTROL METHOD AND APPARATUS, DEVICE, AND STORAGE MEDIUM” filed on Apr. 17, 2023, which claims priority to Chinese Patent Application No. 202210555869.7, entitled “VIRTUAL VEHICLE CONTROL METHOD AND APPARATUS, DEVICE, AND STORAGE MEDIUM” filed on May 20, 2022, both of which are incorporated herein by reference in their entirety.

### FIELD OF THE TECHNOLOGY

This application relates to the field of virtual world technologies, and in particular, to a virtual vehicle control method and apparatus, a device, and a storage medium.

### BACKGROUND OF THE DISCLOSURE

In an application program including a virtual environment, a virtual object generally needs to be controlled to perform a virtual activity in the virtual environment. Using a virtual vehicle as an example, the virtual vehicle needs to be controlled to perform virtual driving in the virtual environment.

In the related art, there is a curve in a virtual road in the virtual environment, and the virtual vehicle is controlled to enter a drift state, so that a steering radius when the virtual vehicle passes through the curve is reduced, to quickly drive to pass through the curve of the virtual road.

When there is a continuous curve in the virtual road, the virtual vehicle easily collides with a virtual roadside prop. In this way, the virtual vehicle slows down, and a capability of the virtual vehicle to pass through the continuous curve needs to be improved.

### SUMMARY

This application provides a virtual vehicle control method and apparatus, a device, and a storage medium, and the technical solutions are as follows.

According to an aspect of this application, a virtual vehicle control method is provided, performed by a terminal, the method including:
displaying a virtual vehicle in a driving state in a virtual environment;
controlling the virtual vehicle to enter a drift state in response to a first steering operation on a direction control component and a brake operation on a handbrake control component, the first steering operation being configured for controlling the virtual vehicle to steer to a first side of a speed direction;
turning the head direction of the virtual vehicle from a first direction to a second direction in response to a second steering operation on the direction control component, the second steering operation being configured for controlling the virtual vehicle to steer to a second side of the speed direction, and a second angle formed between the second direction and the speed direction being less than a first angle formed between the first direction and the speed direction; and turning the head direction of the virtual vehicle from the second direction to a
third direction in response to the brake operation on the handbrake control component, the third direction being located on the second side of the speed direction.

According to another aspect of this application, a computer device is provided, including a processor and a memory, the memory having at least one instruction, at least one program, and a code set or an instruction set stored therein, the at least one instruction, the at least one program, and the code set or the instruction set being loaded and executed by the processor to perform the virtual vehicle control method according to the foregoing aspects.

According to another aspect of this application, a non-transitory computer-readable storage medium is provided, having at least one instruction, at least one program, and a code set or an instruction set stored therein, the at least one instruction, the at least one program, and the code set or the instruction set being loaded and executed by a processor to perform the virtual vehicle control method according to the foregoing aspects.

The technical solution provided in this application includes at least the following beneficial effects:

The head direction of the virtual vehicle is changed by performing the second steering operation when the virtual vehicle is in the drift state; and the drift state of the virtual vehicle is maintained through the brake operation, and the head direction of the virtual vehicle is steered from the first side of the speed direction to the second side of the speed direction without interrupting the drift state. In this way, reverse drifting of the virtual vehicle is implemented, a steering radius when the virtual vehicle passes through a continuous curve is reduced, and a capability of the virtual vehicle to pass through the continuous curve is improved.

### BRIEF DESCRIPTION OF THE DRAWINGS

FIG. 1 is a schematic structural diagram of a terminal according to an exemplary embodiment of this application.

FIG. 2 is a structural block diagram of a computer system according to an exemplary embodiment of this application.

FIG. 3 is a schematic diagram of an interface of a virtual vehicle control method according to an exemplary embodiment of this application.

FIG. 4 is a schematic diagram of an interface of a virtual vehicle control method according to an exemplary embodiment of this application.

FIG. 5 is a flowchart of a virtual vehicle control method according to an exemplary embodiment of this application.

FIG. 6 is a flowchart of a virtual vehicle control method according to an exemplary embodiment of this application.

FIG. 7 is a schematic diagram of an interface of a virtual vehicle control method according to an exemplary embodiment of this application.

FIG. 8 is a flowchart of a virtual vehicle control method according to an exemplary embodiment of this application.

FIG. 9 is a schematic diagram of an interface of a virtual vehicle control method according to an exemplary embodiment of this application.

FIG. 10 is a schematic diagram of an interface of a virtual vehicle control method according to an exemplary embodiment of this application.

FIG. 11 is a flowchart of a virtual vehicle control method according to an exemplary embodiment of this application.

FIG. 12 is a schematic diagram of calculating a drift angle according to an exemplary embodiment of this application.

FIG. 13 is a flowchart of a virtual vehicle control method according to an exemplary embodiment of this application.

FIG. 14 is a flowchart of a virtual vehicle control method according to an exemplary embodiment of this application.

FIG. 15 is a flowchart of a virtual vehicle control method according to an exemplary embodiment of this application.

FIG. 16 is a flowchart of a virtual vehicle control method according to an exemplary embodiment of this application.

FIG. 17 is a flowchart of a virtual vehicle control method according to an exemplary embodiment of this application.

FIG. 18 is a flowchart of a virtual vehicle control method according to an exemplary embodiment of this application.

FIG. 19 is a schematic diagram of an interface of a virtual vehicle control method according to an exemplary embodiment of this application.

FIG. 20 is a structural block diagram of a virtual vehicle control apparatus according to an exemplary embodiment of this application.

FIG. 21 is a structural block diagram of a terminal according to an exemplary embodiment of this application.

### DESCRIPTION OF EMBODIMENTS

The method provided in embodiments of this application can be applied to an application program with a virtual environment and a virtual character. For example, an application program that supports a virtual environment is an application program in which a user can control the movement of a virtual character in the virtual environment. For example, the method provided in this application can be applied to: any program of a virtual reality (VR) application program, an augmented reality (AR) program, a three-dimensional map program, a VR game, an AR game, a first-person shooting (FPS) game, a third-person shooting (TPS) game, a multiplayer online battle arena (MOBA) game, and a simulation game (SLG).

For example, a game based on a virtual environment is formed by a map of one or more game worlds. The virtual environment in the game simulates scenarios in the real world. A user may control a virtual character in the game to perform actions such as walking, running, jumping, shooting, fighting, and driving in the virtual environment, which has relatively high interactivity. In addition, a plurality of users may form a team online to play an arena game.

In some embodiments, the foregoing application programs may be programs such as a shooting game, a racing game, a role-playing game, an adventure game, a sandbox game, and a tactical arena game. A client may support at least one operating system of a Windows operating system, an Apple operating system, an Android operating system, an iOS operating system, and a LINUX operating system, and clients on different operating systems may be connected to and communicate with each other. In some embodiments, the foregoing client is a program adapted to a mobile terminal having a touchscreen. For example, the virtual vehicle control method provided in the embodiments of this application can be applied to an application program supporting a racing game, where a player can perform a virtual racing competition by controlling a virtual vehicle. For another example, the virtual vehicle control method provided in the embodiments of this application can be applied to an application program supporting a role playing game, where the player may meet a requirement of the player for roaming and sightseeing by controlling a virtual vehicle to move in a virtual scene. In some embodiments, the foregoing client is an application program developed based on a three-dimensional engine. For example, the three-dimensional engine is a Unity engine.

A terminal in this application may be a desktop computer, a portable laptop computer, a mobile phone, a tablet computer, an ebook reader, a moving picture experts group audio layer III (MP3) player, a moving picture experts group audio layer IV (MP4) player, or the like. A client supporting a virtual environment is installed and run on the terminal, such as a client supporting a 3D virtual environment of the application program. The application program may be any one of a battle royale (BR) game, a VR application program, an AR program, a 3D map program, a TPS game, a FPS game, and a MOBA game. In some embodiments, the application program may be a standalone application program, such as a standalone 3D game program, or may be an online application program.

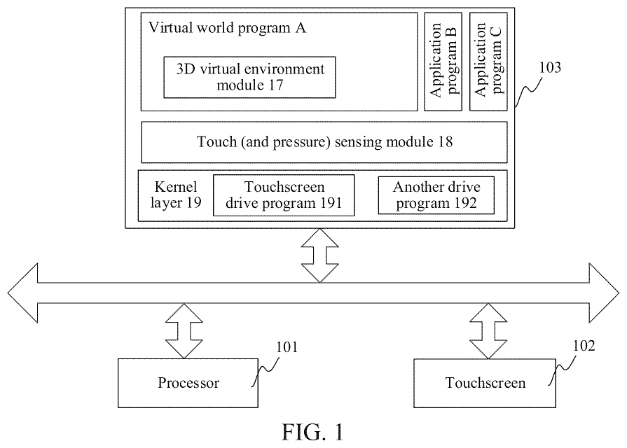

FIG. 1 is a schematic structural diagram of a terminal according to an exemplary embodiment of this application. The terminal includes a processor 101, a touchscreen 102, and a memory 103.

The processor 101 may be at least one of a single-core processor, a multi-core processor, an embedded chip, and a processor having an instruction running capability. The touchscreen 102 includes a normal touchscreen or a pressure sensing touchscreen. The common touch screen can measure a pressing operation or sliding operation applied on the touchscreen 102; and the pressure sensing touchscreen can measure pressing strength applied on the touchscreen 102.

The memory 103 stores programs executable by the processor 101. For example, the memory 103 has a virtual environment program A, an application program B, an application program C, a touch and pressure sensing module 18, and a kernel layer 19 of an operating system stored therein. The virtual environment program A is an application program developed based on a 3D virtual environment module 17. In some embodiments, the virtual environment program A includes, but is not limited to at least one of a game program, a virtual reality program, a three-dimensional map program, and a three-dimensional demonstration program that are developed by the 3D virtual environment module (also referred to as a virtual environment module) 17. For example, when an operating system of the terminal is an Android operating system, the virtual environment program A develops by using Java programming language and C#language. For another example, when an operating system of the terminal is an IOS operating system, the virtual environment program A develops by using Object-C programming language and C#language.

The 3D virtual environment module 17 is a module supporting a plurality of operating system platforms. For example, the 3D virtual environment module may be applied to program development in a plurality of fields such as a game development field, a virtual reality (VR) field, and a three-dimensional map field. A specific type of the 3D virtual environment module 17 is not limited in the embodiments of this application. An example in which the 3D virtual environment module 17 is a module developed by using a Unity engine is used in the following embodiments for description.

The touch (and pressure) sensing module 18 is a module configured to receive a touch event (and a pressure touch and control event) reported by a touchscreen drive program 191. In some embodiments, the touch sensing module may not have a pressure sensing function, and does not receive a pressure touch and control event. The touch event includes: a type and coordinate values of the touch event. The type of the touch event includes, but is not limited to: a touch start event, a touch move event, and a touch down event. The pressure touch and control event includes: a pressure value and coordinate values of the pressure touch and control event. The coordinate values are configured for indicating a touch and control position of a pressure touch and control operation on a display screen. In some embodiments, an x-axis is established in a horizontal direction of the display screen and a y-axis is established in a vertical direction of the display screen, and therefore, a two-dimensional coordinates system is obtained.

For example, the kernel layer 19 includes the touchscreen drive program 191 and another drive program 192. The touchscreen drive program 191 is a module configured to detect a pressure touch and control event. When detecting the pressure touch and control event, the touchscreen drive program 191 transfers the pressure touch and control event to the pressure sensing module 18.

The another drive program 192 may be a drive program related to the processor 101, a drive program related to the memory 103, a drive program related to a network component, a drive program related to a sound component, or the like. A person skilled in the art may learn that the foregoing is only an overview of a structure of the terminal. In different embodiments, the terminal may have more or fewer components. For example, the terminal may further include a gravity acceleration sensor, a gyroscope sensor, a power supply, and the like.

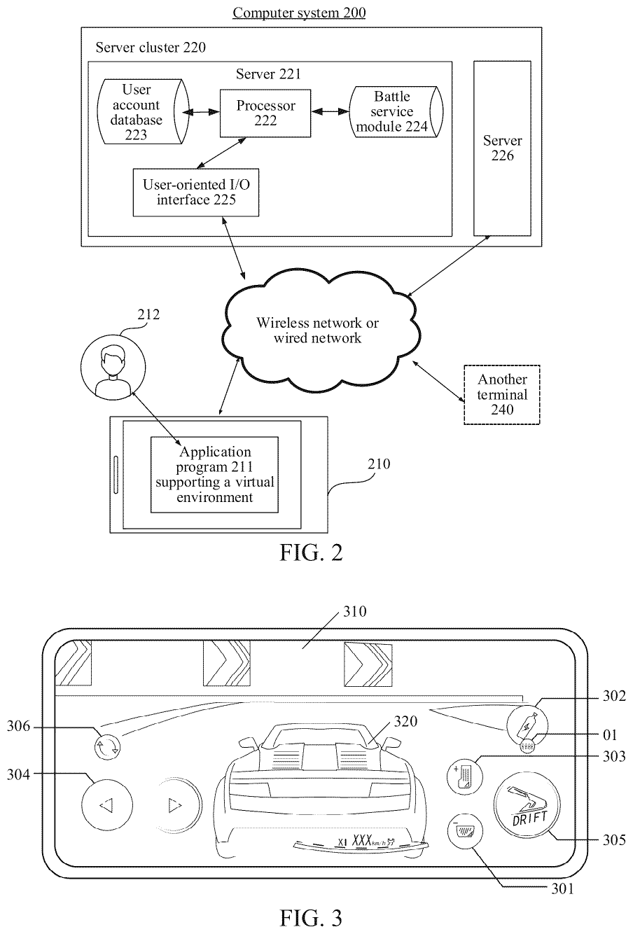

FIG. 2 is a structural block diagram of a computer system according to an exemplary embodiment of this application. A computer system 200 includes: a terminal 210 and a server cluster 220.

A client 211 supporting a virtual environment is installed and run on the terminal 210, and the client 211 may be an application program supporting the virtual environment. When the terminal runs the client 211, a user interface of the client 211 is displayed on a screen of the terminal 210. The client may be any one of a FPS game, a TPS game, a MOBA game, a competitive game, and a SLG. In this embodiment, an example in which the client is a racing game is used for description. The terminal 210 is a terminal used by a first user 212. The first user 212 uses the terminal 210 to control a first virtual character in the virtual environment to perform activities, and the first virtual character may be referred to as a first virtual character of the first user 212. The activities of the first virtual character include, but are not limited to: at least one of adjusting body postures, crawling, walking, running, riding, flying, jumping, driving, picking, shooting, attacking, and throwing. For example, the first virtual character is a first virtual human, for example, a simulated human character or an animated human character.

The device types of the terminal 210 include: at least one of a smartphone, a tablet computer, an e-book reader, an MP3 player, an MP4 player, a laptop portable computer, and a desktop computer. FIG. 2 shows only one terminal. However, a plurality of other terminals 240 exist in different embodiments. In some embodiments, there is at least one of other terminals 240 which is a terminal corresponding to the developer. A developing and editing platform for the client of the virtual environment is installed on the other terminals 240. The developer may edit and update the client on the other terminals 240 and transmit an updated client installation package to the server cluster 220 by using a wired or wireless network. The terminal 210 may download the client installation package from the server cluster 220 to update the client.

The terminal 210 and the other terminals 240 are connected to the server cluster 220 by using a wireless network or a wired network.

The server cluster 220 includes at least one of a server, a plurality of servers, a cloud computing platform, or a virtualization center. The server cluster 220 is configured to provide a background service for a client supporting a virtual environment. In some embodiments, the server cluster 220 is responsible for primary computing work, and the terminal is responsible for secondary computing work; or the server cluster 220 is responsible for secondary computing work, and the terminal is responsible for primary computing work; or a distributed computing architecture is adopted between the server cluster 220 and the terminal to perform collaborative computing.

In some embodiments, the foregoing terminals and servers are computer devices. In a schematic example, the server cluster 220 includes a server 221 and a server 226. The server 221 includes a processor 222, a user account database 223, a battle service module 224, and a user-oriented input/output (I/O) interface 225. The processor 222 is configured to load instructions stored in the server 221, and process data in the user account database 223 and the battle service module 224. The user account database 223 is configured to store data of user accounts used by the terminal 210 and the other terminals 240, for example, avatars of the user accounts, nicknames of the user accounts, battle effectiveness indexes of the user accounts, and service zones of the user accounts. The battle service module 224 is configured to provide a plurality of battle rooms for the user to battle. The user-oriented I/O interface 225 is configured to establish communication with the terminal 210 via a wireless network or a wired network for data exchange.

With reference to the foregoing introduction of the virtual environment and descriptions of the implementation environment, the virtual vehicle control method provided in the embodiments of this application will be described below. For example, the virtual vehicle control method provided in this application may be implemented through an operation by the player on a terminal, or may be implemented through an operation by the player on a handle, a console, or the like connected to the terminal.

In a case of implementing the method through the operation on the terminal, a plurality of control components involved in the virtual vehicle control method provided in the embodiments of this application may each be implemented as a control in a display interface of the terminal; and in a case of implementing the method through the operation on the handle, the console, or the like connected to the terminal, a plurality of control components involved in the virtual vehicle control method provided in the embodiments of this application may each be implemented as a component of the handle, the console, or the like. For example, a direction control component may be implemented as a moving key or joystick on the handle; and for another example, an accelerator control component may be implemented as an accelerator pedal on the console, and the direction control component may be displayed as a steering wheel on the console.

Using an example in which the virtual vehicle control method provided in this application is implemented through the operation by the player on the terminal, FIG. 3 is a schematic diagram of an interface of a virtual vehicle control method according to an exemplary embodiment of this application. A virtual vehicle 320 is displayed in a display interface 310, and the virtual vehicle 320 drives in a virtual scene displayed in the display interface 310.

For example, at least one of the following controls is displayed in the display interface 310: a brake control 301, an energy control 302, an accelerator control 303, a direction control 304, a handbrake control 305, or a reset control 306. Each control is described as follows.

The brake control 301 is configured to control a grip force of the virtual vehicle 320, and the grip force of the virtual vehicle 320 is a friction force existing between tires of the virtual vehicle 320 and the ground. In response to a trigger operation on the brake control 301, a vehicle speed of the virtual vehicle 320 is controlled to decrease. The vehicle speed of the virtual vehicle 320 decreases through the enhancement of the grip force of the virtual vehicle 320, and the decrease of the vehicle speed of the virtual vehicle 320 may be set according to actual requirements. Using an example in which the player single-taps on the brake control 301, in response to a single tap operation on the brake control 301, the friction force existing between the tires of the virtual vehicle 320 and the ground increases, and the grip force of the virtual vehicle increases accordingly, so that the vehicle speed of the virtual vehicle 320 decreases accordingly.

The energy control 302 is configured to indicate an inventory of acceleration energy of the virtual vehicle 320. In response to a trigger operation on the energy control 302, a unit of the acceleration energy may be consumed to provide an acceleration service for the virtual vehicle 320. In some embodiments, a storage amount control 01 of the acceleration energy is displayed on a peripheral side of the energy control 302, and the storage amount control 01 is configured to indicate a storage amount of the acceleration energy corresponding to the virtual vehicle 320. Using an example in which the acceleration energy is nitrogen, the energy control 302 is configured to indicate an inventory of nitrogen that can be used to speed up the virtual vehicle 320, for example, the energy control 302 is configured to indicate an inventory of a bottle of nitrogen. The storage amount control 01 is configured to indicate a quantity of nitrogen bottles corresponding to the virtual vehicle 320. In response to the trigger operation on the energy control 302, a bottle of nitrogen is consumed to provide the acceleration service for the virtual vehicle 320, and information for prompting that the bottle of nitrogen is consumed is displayed in the display interface 310.

The accelerator control 303 is configured to implement increase of the vehicle speed of the virtual vehicle 320. In response to a trigger operation on the accelerator control 303, the virtual vehicle 320 is controlled to accelerate. The trigger operation on the accelerator control 303 may be at least one of a single tap operation, a double tap operation, a touch operation, a continuous pressing operation, or the like. In an embodiment of this application, in response to the trigger operation on the accelerator control 303, a corresponding accelerator of the virtual vehicle 320 automatically remains depressed, so that the virtual vehicle 320 remains continuously accelerating. For example, when the player single-taps on the accelerator control 303 and then releases the accelerator control 303, the virtual vehicle 320 enters a state of continuously accelerating. In some embodiments, the brake control 301 is further configured to implement at least one of an acceleration stop function, a deceleration function, or a reverse function of the virtual vehicle 320 when the virtual vehicle 320 is in the state of continuously accelerating.

In some embodiments, the virtual vehicle 320 is controlled to stop acceleration in response to the trigger operation on the brake control 301 after the virtual vehicle enters the state of continuously accelerating, to simulate an accelerator pop-up state. When the trigger operation on the brake control 301 is the single tap operation, the virtual vehicle 320 is controlled to stop acceleration and enter a constant speed driving state; and when the trigger operation on the brake control 301 is the continuous pressing operation, the virtual vehicle 320 is controlled to stop acceleration and enter a continuous deceleration state. In some embodiments, when the virtual vehicle 320 is in the continuous deceleration state, if the vehicle speed of the virtual vehicle 320 decreases to 0 and a continuous press on the brake control 301 still exists, the virtual vehicle 320 is controlled to enter a reverse state.

In an exemplary implementation, the brake control 301 and the accelerator control 303 cannot be used simultaneously.

The direction control 304 is configured to implement steering of the virtual vehicle 320. The direction control 304 may include a left steering control and a right steering control for implementing left-right steering of the virtual vehicle 320. The handbrake control 305 is configured to implement braking of the virtual vehicle 320. In a flat running state, the vehicle speed of the virtual vehicle 320 is controlled to decrease in response to a trigger operation on the handbrake control 305. In some embodiments, the virtual vehicle 320 enters a drift state in a curve in response to simultaneous trigger operations on the direction control 304 and the handbrake control 305. In some embodiments, in the drift state, in response to the trigger operation on the handbrake control 305, a head of the virtual vehicle 320 is controlled to rotate inward, and a decrease of the vehicle speed of the virtual vehicle 320 is greater than that of the virtual vehicle 320 in the flat running state.

The reset control 306 is configured to restart the virtual vehicle 320. In response to a trigger operation on the reset control 306, the virtual vehicle 320 is controlled to be displayed on an open road surface on the peripheral side, and the virtual vehicle 320 is controlled to be restarted. The reset control 306 is generally used in a process of detrapping of the virtual vehicle 32.

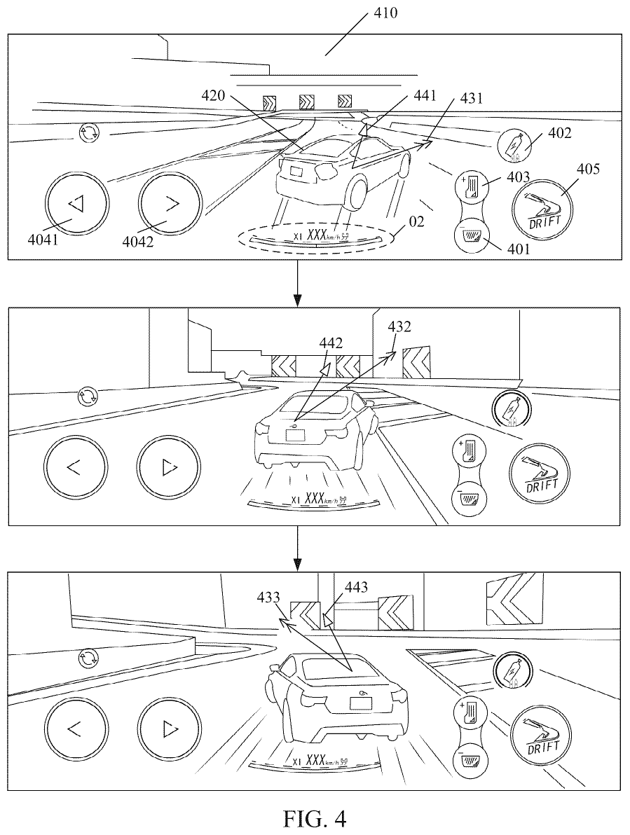

FIG. 4 is a schematic diagram of an interface of a virtual vehicle control method according to an exemplary embodiment of this application. Similar to FIG. 3, a virtual vehicle 420 is displayed in a display interface 410. The virtual vehicle 420 is in a drift state in a curve, the drift state may also be referred to as a tail flick state, and the virtual vehicle 420 sideslips in an over-steer manner in the drift state.

The virtual vehicle control method provided in the embodiments of this application includes:
controlling the virtual vehicle to enter a drift state in response to a first steering operation on a direction control component and a brake operation on a handbrake control component, the first steering operation being configured for controlling the virtual vehicle to steer to a first side of a speed direction, a head direction of the virtual vehicle being a first direction, and the first direction being located on the first side of the speed direction; controlling the head direction of the virtual vehicle maintaining the drift state to be turned to a second direction in response to a second steering operation on the direction control component, the second steering operation being configured for controlling the virtual vehicle to steer to a second side of the speed direction, the second direction being located on the first side of the speed direction, and a second angle formed between the second direction and the speed direction being less than a first angle formed between the first direction and the speed direction; and
controlling the head direction of the virtual vehicle maintaining the drift state to be turned to a third direction in response to the brake operation on the handbrake control component, the third direction being located on the second side of the speed direction. Using an example in which the virtual vehicle control method provided in this application is implemented through the operation by the player on the terminal, referring to FIG. 4, a brake control component, an energy control component, and an accelerator control component may each be displayed in the display interface 410 in a form of a control. A brake control 401, an energy control 402, an accelerator control 403, a left turn control 4041, a right turn control 4042, and a handbrake control 405 are displayed in the display interface 410 respectively.

For example, in response to a first steering operation on the right turn control 4042 in the direction control component and a brake operation on the handbrake control 405, the virtual vehicle 420 is controlled to enter the drift state. For example, a vehicle condition display region 02 is displayed in the display interface 410, and the vehicle condition display region 02 is configured for showing a driving state of the virtual vehicle 420, including at least numerical information of a vehicle speed and/or a vehicle speed display bar of the virtual vehicle 420. For example, in response to the brake operation on the handbrake control 405, the virtual speed indicated by the numerical information of the vehicle speed and/or the vehicle speed display bar of the virtual vehicle 420 in the vehicle condition display region 02 decreases.

For example, the virtual vehicle 420 in the drift state is displayed with a virtual trace caused by tire friction in the virtual road; and the first steering operation on the right turn control 4042 in the direction control component is configured to control the virtual vehicle 420 to steer to a right side of the speed direction. A head direction of the virtual vehicle 420 is a first direction 431, and the head direction of the virtual vehicle 420, that is, the first direction 431, is located on a right side of a first speed direction 441. The head direction of the virtual vehicle 420, that is, the first direction 431, and the first speed direction 441 are not on a same straight line, and a drift angle of the virtual vehicle is an angle formed between the first direction 431 and the first speed direction 441. The first speed direction 441 is a speed direction of the virtual vehicle 420 when the head direction of the virtual vehicle 420 is the first direction 431. For example, the first speed direction 441 is a tangential direction at a position at which the head direction is the first direction 431 in a driving trace of the virtual vehicle. In response to a second steering operation on the left turn control 4041 in the direction control component, the head direction of the virtual vehicle 420 maintaining the drift state is controlled to be turned to a second direction 432.

For example, the second steering operation on the left turn control 4041 in the direction control component is configured to control the virtual vehicle 420 to steer to a left side of the speed direction. Since the virtual vehicle 420 maintains the drift state, the virtual trace caused by the tire friction is displayed in the virtual road. The head direction of the virtual vehicle 420 is turned to the second direction 432, and the head direction of the virtual vehicle 420, that is, the second direction 432, is located on a right side of a second speed direction 442. The head direction of the virtual vehicle 420, that is, the second direction 432, and the second speed direction 442 are not on a same straight line. A second angle formed between the second direction 432 and the second speed direction 442 is less than a first angle formed between the first direction 431 and the first speed direction 441. The second speed direction 442 is a speed direction of the virtual vehicle 420 when the head direction of the virtual vehicle 420 is the second direction 432. In response to the brake operation on the handbrake control 405, the head direction of the virtual vehicle 420 maintaining the drift state is controlled to be turned to a third direction 433. For example, since the virtual vehicle 420 maintains the drift state, the virtual trace caused by the tire friction is displayed in the virtual road.

For example, during steering of the virtual vehicle 420 to the left side of the speed direction, the head direction of the virtual vehicle 420 maintaining the drift state is controlled to be turned to the third direction 433 through the brake operation on the handbrake control 405. For example, the brake operation on the handbrake control 405 is performed after the second steering operation on the left turn control 4041 in the direction control component is performed.

In an exemplary manner, in response to the second steering operation on the left turn control 4041 in the direction control component and the brake operation on the handbrake control 405, the head direction of the virtual vehicle 420 maintaining the drift state is controlled to be turned to the third direction 433, that is, the second steering operation on the left turn control 4041 in the direction control component and the brake operation on the handbrake control 405 are performed simultaneously. The head direction of the virtual vehicle 420 is turned to the third direction 433, and the head direction of the virtual vehicle 420, that is, the third direction 433, is located on a left side of a third speed direction 443. The head direction of the virtual vehicle 420, that is, the third direction 433, and the third speed direction 443 are not on a same straight line.

The third speed direction 443 is a speed direction of the virtual vehicle 420 when the head direction of the virtual vehicle 420 is the third direction 433.

For example, for the speed direction of the virtual vehicle described above, an iterative calculation may be performed through the following formulas:

$$v ( t + Δ t ) = grip force \times ( d ( t + Δ t ) - v ( t ) ) + v ( t ) ;$$

$$v ( t + 2 \times Δ t ) = grip force \times ( d ( t + 2 \times Δ t ) - v ( t + Δ t ) ) + v ( t + Δt ) ;$$

$$…$$

$$v ( t + n \times Δ t ) = grip force \times [ d ( t + n \times Δ t ) - v ( t + ( n - 1 ) \times Δ t ) ] + v ( t + ( n - 1 ) \times Δ t ) .$$

A speed direction of the virtual vehicle at an initial moment t is v(t), a head direction at the initial moment t is d(t), and a unit time is Δt. In this case, a drifting angle of the virtual vehicle 420 at the initial moment t is d(t)−v(t), that is, the drifting angle is an angle between the head direction and the speed direction. A speed direction of the virtual vehicle 420 at a moment t+Δt is v(t+Δt), and a head direction of the virtual vehicle 420 at the moment t+Δt is d(t+Δt). Subsequently, a drifting angle of the virtual vehicle 420 at the moment t+Δt may be calculated by d(t+Δt)−v(t+Δt), and so on for remaining information.

In some embodiments, a drifting angle of the virtual vehicle at an i^{th} moment is a difference between a head direction of the virtual vehicle at the i^{th} moment and a speed direction of the virtual vehicle at the i^{th} moment. For example, the drifting angle of the virtual vehicle 420 at the initial moment t is d(t)−v(t).

For example, a speed direction of the virtual vehicle at a second moment may be determined according to a grip force, a head direction at the second moment, and a speed direction at a first moment. The second moment is a moment after a unit time has elapsed from the first moment, and the head direction of the virtual vehicle at the second moment is a sum of a head direction of the virtual vehicle at the first moment and a turning angle of the virtual vehicle in the unit time.

For example, the speed direction of the virtual vehicle at the second moment is a sum of a result of a difference between the head direction of the second moment and the speed direction at the first moment multiplied by the grip force plus the speed direction at the first moment. For example, the speed direction of the virtual vehicle 420 at the moment t+Δt is v(t+Δt), which can be calculated by v(t+Δt)=grip force×(d(t+Δt)−v(t))+v(t).

In some embodiments, the unit time Δt may be calculated in a unit of one frame, and the grip force is a fixed function.

For example, assuming that the grip force of the virtual vehicle 420 is constant at 0.5, an initial direction of the head direction of the virtual vehicle 420 is straight ahead, d(t)=90°, and an initial speed direction of the virtual vehicle 420 is that v(t)=15°. In this case, a drifting angle of the virtual vehicle 420 at the moment t (the moment is the initial moment) is that 90°-15°=75°. Subsequently, the head direction of the virtual vehicle 420 is turned by 15° towards the left within time Δt, that is, d(t+Δt)=105°.

Based on the foregoing formulas, assuming that Δt=1, by the foregoing formula, the speed direction of the virtual vehicle 420 may be calculated as that v(t+Δt)=0.5×(105°−15°)+15°=60°, and the drifting angle of the virtual vehicle 420 at the moment t+Δt is that 105°−60°=45°.

In some embodiments, when the angle between the head direction and the speed direction of the virtual vehicle 420 is less than a de-drift angle, it is determined that the virtual vehicle 420 finishes de-drifting and exits the drift state, and then the virtual vehicle 420 is controlled to enter the flat running state. The de-drifting angle may be set according to actual requirements. For example, the de-drifting angle is 13 degrees.

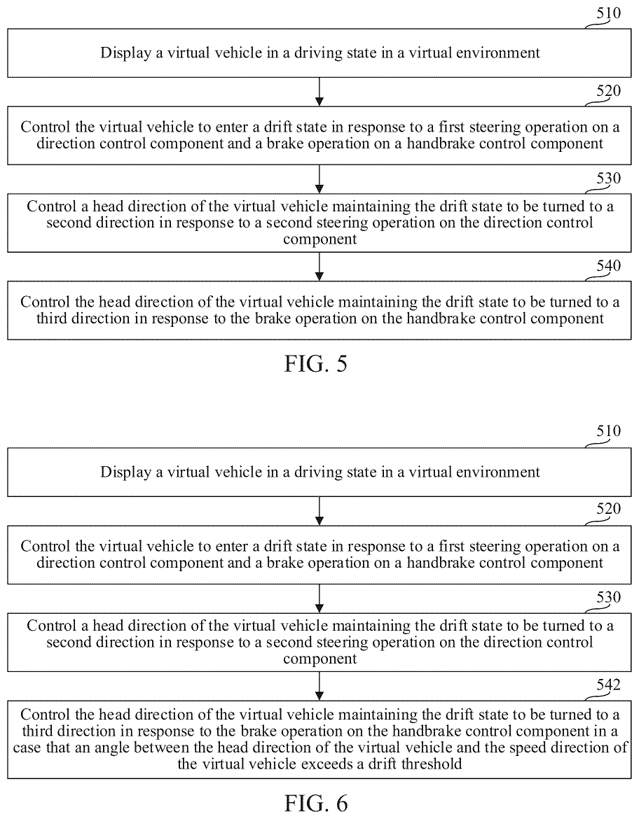

FIG. 5 is a flowchart of a virtual vehicle control method according to an exemplary embodiment of this application. The method may be applied in a terminal supporting a virtual environment, and the method includes the following operations.

Operation 510: Display a virtual vehicle in a driving state in a virtual environment.

For example, the virtual environment is configured for providing a lot for the virtual vehicle to drive.

For example, the virtual vehicle control method is applied to an application program supporting a racing game, and a player performs a virtual racing competition in the virtual environment by controlling the virtual vehicle; or the virtual vehicle control method is applied to an application program supporting a role playing game, and a player meets a requirement of the player for roaming and sightseeing by controlling the virtual vehicle to move in the virtual environment.

Operation 520: Control the virtual vehicle to enter a drift state in response to a first steering operation on a direction control component and a brake operation on a handbrake control component.

For example, the first steering operation is configured for controlling the virtual vehicle to steer to a first side of a speed direction; and the first side is generally a left side or a right side, and correspondingly, a second side is a side opposite to the first side. A head direction of the virtual vehicle is a first direction, and the first direction is located on the first side of the speed direction. The speed direction is a corresponding speed direction when the head direction is the first direction.

For example, the drift state may also be referred to as a tail flick state, and the virtual vehicle drives sideslip in an over-steer manner in the drift state, to facilitate the virtual vehicle exiting the curve. In this embodiment, the virtual vehicle is controlled to enter the drift state in response to the first steering operation on the direction control component and the brake operation on the handbrake control component. For example, the left turn control and the handbrake control in the direction control component are simultaneously single-taped on to control the virtual vehicle to drift to the left side. In another implementation, the left turn control and the handbrake control in the direction control component are single-taped on successively to control the virtual vehicle to drift to the left side.

The direction control component and the handbrake control component may be implemented as controls in a display interface of the terminal, or may be implemented as a part of a handle or a console connected to the terminal. For example, the direction control component and the handbrake control component may be implemented as a direction control and a handbrake control respectively on the terminal; for another example, the direction control component may be implemented as a moving key or joystick on the handle, and the handbrake control component may be implemented as a confirmation key on the handle; and for another example, the direction control component and the handbrake control component may be implemented as a steering wheel and a brake handbrake respectively on the console.

For example, the handbrake control component is configured to implement braking of the virtual vehicle, to control the vehicle speed of the virtual vehicle to decrease.

Operation 530: Control the head direction of the virtual vehicle maintaining the drift state to be turned to a second direction in response to a second steering operation on the direction control component.

The second steering operation is configured for controlling the virtual vehicle to steer to the second side of the speed direction; and the second side is a side opposite to the first side. For example, when the first side is the left side, the second side is the right side.

The second direction is located on the first side of the speed direction, and the speed direction corresponding to the second direction is a corresponding speed direction when the head direction is the second direction. For example, the speed direction is a tangential direction at a position at which the head direction is the second direction in a driving trace of the virtual vehicle. A second angle formed between the second direction and the speed direction is less than a first angle formed between the first direction and the speed direction. For example, the virtual vehicle maintains the drift state during turning to the second direction.

Operation 540: Control the head direction of the virtual vehicle maintaining the drift state to be turned to a third direction in response to the brake operation on the handbrake control component.

For example, the handbrake control component is configured to implement braking of the virtual vehicle, to control the vehicle speed of the virtual vehicle to decrease. In an implementation, the brake operation on the handbrake control component is a single tap on the handbrake control component, and the handbrake component is configured to significantly reduce the virtual speed of the virtual vehicle in a short period of time. Compared to a footbrake control component, the handbrake control component decreases more virtual speed per unit time than the footbrake control component.

The third direction is located on the second side of the speed direction. For example, the virtual vehicle changes from drifting to the first side to drifting to the second side. For example, the virtual vehicle maintains the drift state during turning to the third direction.

In conclusion, in the method provided in this embodiment, the head direction of the virtual vehicle is changed by performing the second steering operation when the virtual vehicle is in the drift state; and the drift state of the virtual vehicle is maintained through the brake operation, and the head direction of the virtual vehicle is steered from the first side of the speed direction to the second side of the speed direction without interrupting the drift state. In this way, reverse drifting of the virtual vehicle is implemented, a steering radius when the virtual vehicle passes through a continuous curve is reduced, and a capability of the virtual vehicle to pass through the continuous curve is improved.

FIG. 6 is a flowchart of a virtual vehicle control method according to an exemplary embodiment of this application. The method may be applied in a terminal supporting a virtual environment. That is, in the embodiment shown in FIG. 5, operation 540 may be implemented as operation 542.

Operation 542: Control the head direction of the virtual vehicle maintaining the drift state to be turned to the third direction in response to the brake operation on the handbrake control component when an angle between the head direction of the virtual vehicle and the speed direction of the virtual vehicle exceeds a drift threshold.

For example, an angle is constructed by using the speed direction of the virtual vehicle and the head direction of the virtual vehicle as two sides, and the angle is less than 180 degrees. For example, the drift threshold is configured for determining whether the virtual vehicle is in the drift state; and when the angle between the head direction of the virtual vehicle and the speed direction of the virtual vehicle exceeds the drift threshold, the virtual vehicle maintains the drift state. For example, the drift threshold is 13 degrees. When the virtual vehicle maintains the drift state, the head direction of the virtual vehicle is turned to the third direction in response to the brake operation on the handbrake control component.

For example, the virtual vehicle changes from drifting to the first side to drifting to the second side.

In some embodiments, in an implementation, operation 542 in the embodiments may be implemented as the following sub-operations.

Control the head direction of the virtual vehicle maintaining the drift state to be turned to the third direction and display release information of a reverse drift skill in response to the brake operation on the handbrake control component when the angle between the head direction of the virtual vehicle and the speed direction of the virtual vehicle exceeds the drift threshold.

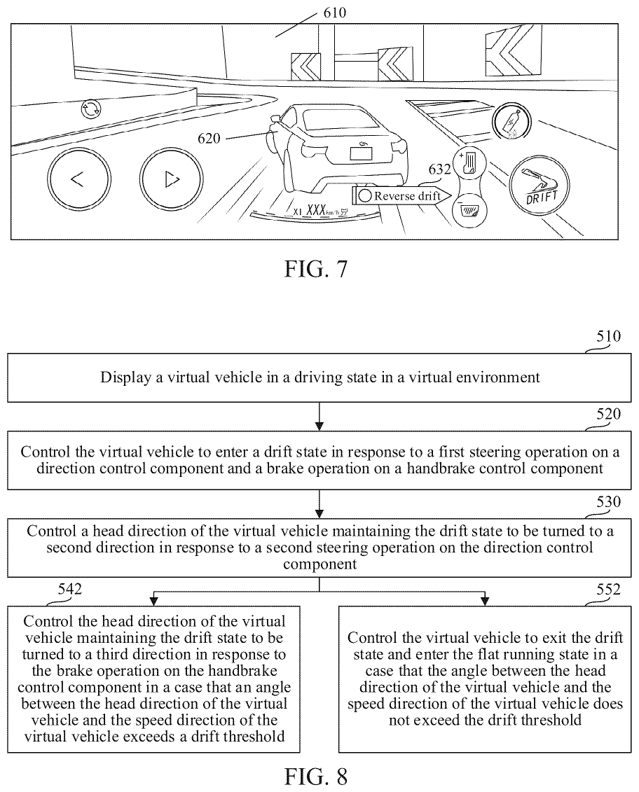

For example, the reverse drift skill is configured for indicate that the virtual vehicle changes from drifting to the first side to drifting to the second side. The release information of the reverse drift skill may be at least one of text information, a highlight special effect, a flash special effect, an aperture special effect, or a sound special effect. FIG. 7 is a schematic diagram of an interface of a virtual vehicle control method according to an exemplary embodiment of this application. A virtual vehicle 620 is displayed in a display interface 610, and the virtual vehicle 620 drives in a virtual scene displayed in the display interface 610. When the virtual vehicle 620 changes from drifting to the first side to drifting to the second side, that is, the head direction of the virtual vehicle is the third direction, release information 632 of the reverse drift skill is displayed, and the release information 632 indicates that the reverse drift skill is triggered. For example, at least one of a virtual economic value, a virtual empirical value, or a virtual task progress increases when the reverse drift skill is triggered.

In conclusion, in the method provided in this embodiment, the driving state of the virtual vehicle is determined through the drift threshold, and the drift state of the virtual vehicle is maintained through the brake operation when the virtual vehicle is in the drift state, which realizes reverse drifting of the virtual vehicle without interrupting the drift state, reduces a turning radius when the virtual vehicle passes through a continuous curve, and improves a capability of the virtual vehicle to pass through the continuous curve.

Next, the brake operation after the second steering operation is further explained.

After the virtual vehicle enters the drift state, the virtual vehicle drives sideslip in an over-steer manner, also referred to as a tail flick state. After the virtual vehicle enters the drift state, the angle between the head direction of the virtual vehicle and the speed direction of the virtual vehicle needs to exceed the drift threshold to maintain the drift state. Steering directions indicated by the second steering operation and the first steering operation are opposite, and the second steering operation causes the angle between the head direction of the virtual vehicle and the speed direction of the virtual vehicle to decrease. The grip force between the virtual vehicle and the ground is controlled to be reduced by performing the brake operation again, so that the vehicle continues to maintain the drift state.

Whether the virtual vehicle is in the drift state may be determined through at least one of the grip force or the drift threshold. For example: 1 Maintain the drift state when the angle between the head direction of the virtual vehicle and the speed direction of the virtual vehicle exceeds the drift threshold. 2 Maintain the drift state when the grip force between the virtual vehicle and the ground is less than a mechanical feature threshold. The mechanical feature threshold may be preset or determined according to a virtual weight of the virtual vehicle. 3 There is a correlation between the drift threshold and the grip force between the virtual vehicle and the ground, the drift threshold is an angle threshold, and the drift threshold decreases as the grip force decreases. In an example, as the grip force decreases, even if the head direction of the virtual vehicle is in the same direction as the speed direction of the virtual vehicle, the virtual vehicle is still in a slipping state due to the small grip force, and the vehicle maintains the drift state. By determining whether the virtual vehicle is in the drift state through at least one of the grip force or the drift threshold, the virtual vehicle is controlled in the virtual environment to perform simulated pendulum vehicle drifting by driving away from the real world.

FIG. 8 is a flowchart of a virtual vehicle control method according to an exemplary embodiment of this application. The method may be applied in a terminal supporting a virtual environment. That is, based on the embodiment shown in FIG. 6, operation 552 is further included.

Operation 552: Control the virtual vehicle to exit the drift state and enter the flat running state when the angle between the head direction of the virtual vehicle and the speed direction of the virtual vehicle does not exceed the drift threshold.

For example, an angle is constructed by using the speed direction of the virtual vehicle and the head direction of the virtual vehicle as two sides, and the angle is less than 180 degrees. For example, the drift threshold is configured for determining whether the virtual vehicle is in the drift state; and the virtual vehicle exits the drift state and enters the flat running state when the angle between the head direction of the virtual vehicle and the speed direction of the virtual vehicle does not exceed the drift threshold. For example, the drift threshold is 13 degrees. For example, in the flat running state, the virtual vehicle does not drive sideslip. In an example, the flat running state indicates that the head direction of the virtual vehicle and the speed direction of the virtual vehicle are on the same line. To avoid the catching of entering the flat running state, the virtual vehicle enters the flat running state when the angle between the head direction of the virtual vehicle and the speed direction of the virtual vehicle is less than the drift threshold.

The virtual vehicle exiting the drift state indicates the end of the drift state of the virtual vehicle. In some embodiments, when the virtual vehicle is in the drift state, a virtual trace caused by the tire friction is displayed on the virtual road in the virtual environment.

FIG. 9 is a schematic diagram of an interface of a virtual vehicle control method according to an exemplary embodiment of this application. A virtual vehicle 642 is displayed in a display interface 640, and the virtual vehicle 642 drives in a virtual scene displayed in the display interface 640. A position of the virtual vehicle 642 is at a fourth position point 646b.

There are two virtual traces of the virtual vehicle 642 on the virtual road, and a first virtual trace 644 is a trace on the virtual road caused by the virtual vehicle 642 in a first drift state. The virtual vehicle 642 enters the first drift state at the first position point 644a and exits the first drift state at a second position point 644b; and the virtual vehicle 642 drifts to the left in the first drift state.

The virtual vehicle 642 enters the flat running state at the second position point 644b, and the virtual vehicle 642 maintains the flat running state between the second position point 644b and a third position point 646a. No trace is made on the virtual road when the virtual vehicle 642 is in the flat running state. A second virtual trace 646 is a trace on the virtual road caused by the virtual vehicle 642 is in a second drift state. The virtual vehicle 642 enters the second drift state at the third position point 646a, and the virtual vehicle 642 drifts to the right in the second drift state. The virtual vehicle 642 maintains the second drift state between the third position point 646a and a fourth position point 646b.

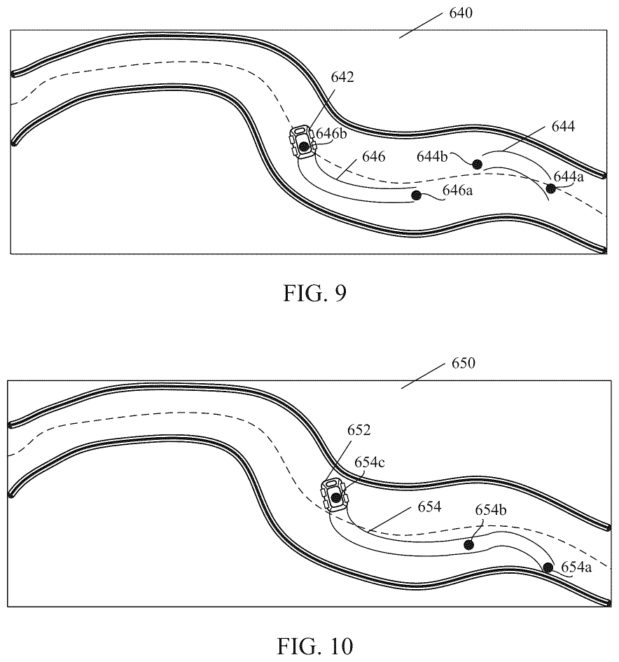

FIG. 10 is a schematic diagram of an interface of a virtual vehicle control method according to an exemplary embodiment of this application. A virtual vehicle 652 is displayed in a display interface 650, and the virtual vehicle 652 drives in a virtual scene displayed in the display interface 650. A position of the virtual vehicle 652 is at a third position point 654c.

There is a virtual trace of the virtual vehicle 652 on the virtual road, and the continuous virtual trace 654 is a trace on the virtual road caused by the virtual vehicle 652 in a continuous drift state. The virtual vehicle 642 enters the continuous drift state at a first position point 654a, and the virtual vehicle 642 maintains the continuous drift state between the first position point 654a and the third position point 654c. The virtual vehicle 642 drifts to the left and then to the right in the continuous drift state. Specifically, the virtual vehicle 642 keeps drifting to the left between the first position point 654a and a second position point 654b; and the virtual vehicle 642 keeps drifting to the right between the second position point 654b and the third position point 654c, that is, the virtual vehicle 642 changes from drifting to the left to drifting to the right at the second position point 654b.

In conclusion, in the method provided in this embodiment, the driving state of the virtual vehicle is determined through the drift threshold, and the virtual vehicle exits the drift state and enters the flat running state when the angle between the head direction of the virtual vehicle and the speed direction of the virtual vehicle does not exceed the drift threshold, which can control the driving state of the virtual vehicle more flexibly and improve maneuverability of the virtual vehicle; and a flat running state is entered without the angle exceeding the drift threshold, which is close to real-world driving principles.

FIG. 11 is a flowchart of a virtual vehicle control method according to an exemplary embodiment of this application. The method may be applied in a terminal supporting a virtual environment. That is, based on the embodiment shown in FIG. 6, operation 535 is further included.

Operation 535: Determine the speed direction of the virtual vehicle according to a grip force of the virtual vehicle, the head direction of the virtual vehicle, and a historical speed direction of the virtual vehicle.

For example, the angle between the head direction of the virtual vehicle and the speed direction of the virtual vehicle is a drifting angle. The larger the drifting angle, the higher the degree of body shift of the virtual vehicle, and the longer the time required to cause the virtual vehicle to exit the drift state. In addition, the drifting angle is affected by the grip force of the virtual vehicle, and a change of the grip force is implemented by the trigger operation on the brake control component. When the virtual vehicle is in the flat running state, the speed direction of the virtual vehicle substantially coincides with the head direction. In this case, the drifting angle of the virtual vehicle may be determined to be 0 degrees. When the virtual vehicle is in the reverse state, the speed direction of the virtual vehicle is opposite to the head direction. In this case, the drifting angle of the virtual vehicle may be determined to be 180 degrees.

When the virtual vehicle is in the drift state, the speed direction of the virtual vehicle does not coincide with the head direction. That is, the speed direction of the virtual vehicle is a first direction, the head direction is a second direction, the first direction and the second direction are different directions, there is a deviation angle between the first direction and the second direction, and the deviation angle is the drifting angle. Similarly, precisely due to existence of the drifting angle, the virtual vehicle presents a drifting body posture.

For example, the grabbing effect of the virtual vehicle may be achieved by stepwise rotation of the speed direction of the virtual vehicle toward the head direction, eventually causing the virtual vehicle to de-drift to return to the flat running state.

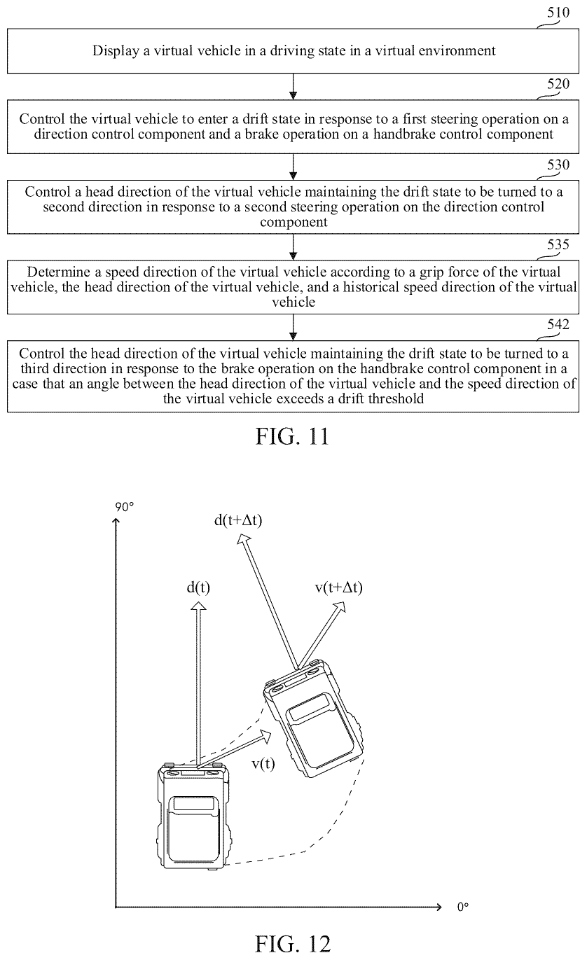

The speed direction of the virtual vehicle at an initial moment t is v(t), the head direction at the initial moment t is d(t), and a unit time is Δt. FIG. 12 is a schematic diagram of calculating a drifting angle according to an exemplary embodiment of this application.

For example, an iterative operation of the speed direction of the virtual vehicle may be performed by the following formulas.

$$v ( t + Δ t ) = grip force \times ( d ( t + Δ t ) - v ( t ) ) + v ( t ) ;$$

$$v ( t + 2 \times Δ t ) = grip force \times ( d ( t + 2 \times Δ t ) - v ( t + Δ t ) ) + v ( t + Δt ) ;$$

$$… …$$

$$v ( t + n \times Δ t ) = grip force \times [ d ( t + n \times Δ t ) - v ( t + ( n - 1 ) \times Δ t ) ] + v ( t + ( n - 1 ) \times Δ t ) .$$

A speed direction of the virtual vehicle 420 at an initial moment t is v(t), a head direction at the initial moment t is d(t), and a unit time is Δt. In this case, a drifting angle of the virtual vehicle 420 at the initial moment t is d(t)−v(t), a speed direction of the virtual vehicle 420 at the moment t+Δt is v(t+Δt), and a head direction of the virtual vehicle 420 at a moment t+Δt is d(t+Δt). Subsequently, a drifting angle of the virtual vehicle 420 at the moment t+Δt may be calculated by d(t+Δt)−v(t+Δt), and so on for remaining information.

In some embodiments, a drifting angle of the virtual vehicle at an i^{th} moment is a difference between a head direction of the virtual vehicle at the i^{th} moment and a speed direction of the virtual vehicle at the i^{th} moment. For example, the drifting angle of the virtual vehicle 420 at the initial moment t is d(t)−v(t).

In addition, a speed direction of the virtual vehicle at a second moment may be determined according to a grip force, a head direction at the second moment, and a speed direction at a first moment. The second moment is a moment after a unit time has elapsed from the first moment, and the head direction of the virtual vehicle at the second moment is a sum of a head direction of the virtual vehicle at the first moment and a turning angle of the virtual vehicle in the unit time.

For example, the speed direction of the virtual vehicle at the second moment is a sum of a result of a difference between the head direction of the second moment and the speed direction at the first moment, multiplied by the grip force, plus the speed direction at the first moment. For example, the speed direction of the virtual vehicle 420 at the moment t+Δt is v(t+Δt), which can be calculated by v(t+Δt)=grip force×(d(t+Δt)−v(t))+v(t).

In some embodiments, the unit time Δt may be calculated in a unit of one frame and the grip force is a fixed function.

According to the foregoing formula, the drifting angle of the virtual vehicle at the initial moment t is d(t)−v(t), the speed direction of the virtual vehicle at the moment t+Δt is v(t+Δt), the head direction of the virtual vehicle 420 at the moment t+Δt is d(t+Δt), and so on for the remaining information. Using an example in which the drifting angle of the virtual vehicle 420 at the initial moment t is d(t)−v(t), and the speed direction of the virtual vehicle 420 at the moment t+Δt is v(t+Δt), the drifting angle of the virtual vehicle 420 at the moment t+Δt can be calculated through d(t+Δt)−v(t+Δt).

Referring to FIG. 12, assuming that the grip force of the virtual vehicle is constant at 0.5, an initial direction of the head direction of the virtual vehicle is straight ahead, d(t)=90°, and an initial speed direction of the virtual vehicle is that v(t)=15°. In this case, a drifting angle of the virtual vehicle at the moment t (the moment is the initial moment) is that 90°-15°=75°. Subsequently, the head direction of the virtual vehicle is turned by 15° toward the left within time Δt, that is, d(t+Δt)=105°. Based on the foregoing formulas, assuming that Δt=1, by the foregoing formula, the speed direction of the virtual vehicle can be calculated as that) v(t+Δt)−0.5×(105°−15°)+15°=60°, and the drifting angle of the virtual vehicle at the moment t+Δt is that 105°−60°−45°. Similarly, the drifting angle of the virtual vehicle at a next moment may continue to be calculated iteratively according to the foregoing formula.

According to the foregoing, through a first trigger operation on the brake control component, the grip force of the virtual vehicle can increase, thereby affecting a change in the drifting angle of the virtual vehicle. The increase of the grip force can accelerate the speed at which the drifting angle decreases, thereby accelerating the virtual vehicle to de-drift from the drift state to enter the flat running state.

In conclusion, in the method provided in this embodiment, the speed direction of the virtual vehicle is determined by introducing the grip force, a connection is established between the speed direction and the head direction and the grip force, and an accurate basis for determining the driving state of the virtual vehicle is ensured through iterative operations, which is close to the driving principles of the real world.

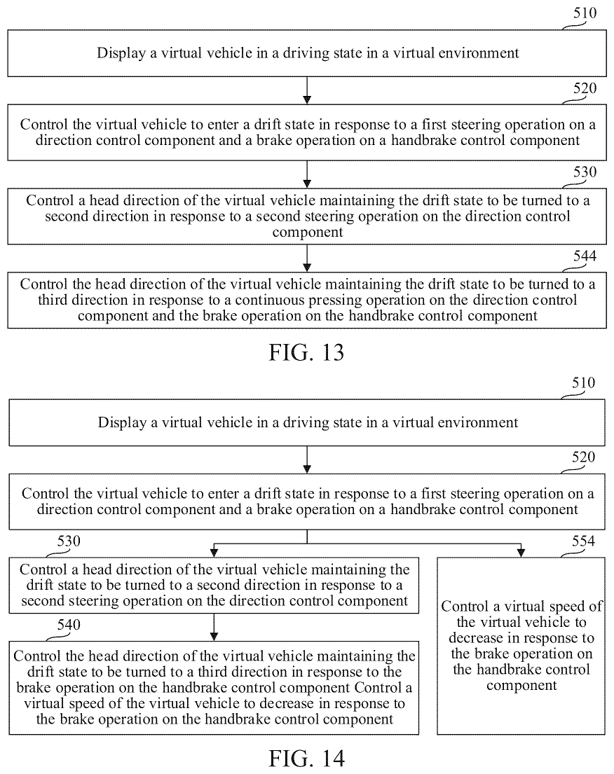

FIG. 13 is a flowchart of a virtual vehicle control method according to an exemplary embodiment of this application. The method may be applied in a terminal supporting a virtual environment. That is, in the embodiment shown in FIG. 5, operation 540 may be implemented as operation 544.

Operation 544: Control the head direction of the virtual vehicle maintaining the drift state to be turned to the third direction in response to the continuous pressing operation on the direction control component and the brake operation on the handbrake control component.

For example, the second steering operation is a continuous pressing operation on the direction control component. In this embodiment, the head direction of the virtual vehicle maintaining the drift state is controlled to be turned to the third direction in response to the continuous pressing operation and the brake operation on the direction control component simultaneously. For example, the brake operation on the handbrake control component may be at least one of the following operations: a single tap operation, a double tap operation, a touch operation, a single pressing operation, or a continuous pressing operation. For example, the player single-taps on the handbrake control component to control the speed of the virtual vehicle to decrease. For example, the virtual vehicle is controlled to steer continuously to the third direction through the continuous pressing operation on the direction control component. The virtual vehicle is controlled to maintain the drift state through the brake operation on the handbrake control component, and the virtual vehicle is prevented from exiting the drift state and entering the flat running state.

In conclusion, in the method provided in this embodiment, through determining the first steering operation as the continuous pressing operation and simultaneously performing the continuous pressing operation and the brake operation on the direction control component, the virtual vehicle is controlled to maintain the drift state and change from drifting to the first side to drifting to the second side, which is close to the driving principles of the real world.

In an exemplary implementation, a first state timer is triggered upon the vehicle entering the drift state and in response to ending the first steering operation, the first steering operation generates an acceleration to the virtual vehicle towards the first side, and the acceleration decreases over time after the first steering operation is ended. Before expiration of the first state timer, the virtual vehicle is in the drift state, and after the expiration of the first state timer, the virtual vehicle exits the drift state. A timing length of the first state timer may be preset or may be determined according to the virtual weight of the virtual vehicle. For example, the timing length and the virtual weight are positively correlated. In some embodiments, when the first state timer maintains the drift state, the first steering operation is triggered again, and when the first steering operation is ended, the first state timer counts back.

Before the expiration of the first state timer, in response to the second steering operation, the head direction of the virtual vehicle maintaining the drift state is controlled to be turned to the second direction; and in response to the brake operation, the head direction of the virtual vehicle maintaining the drift state is controlled to be turned to the third direction. During the turning to the third direction, the brake operation is configured for controlling the virtual vehicle to maintain the drift state. For a detailed instruction of maintaining the drift state, refer to the introduction on the grip force and the drift threshold. The virtual vehicle turns to the third direction due to virtual inertia caused by the second steering operation.

In some embodiments, a second state timer is triggered upon the vehicle maintaining the drift state and in response to ending the second steering operation, the second steering operation generates an acceleration to the virtual vehicle towards the second side, and the acceleration decreases over time after the second steering operation is ended. Before expiration of the second state timer, the virtual vehicle turns to the third direction in response to the brake operation, and after the expiration of the second state timer, the virtual vehicle no longer steers in response to the brake operation. Similarly, a timing length of the second state timer may be preset or determined according to the virtual weight of the virtual vehicle. Similarly, a case in which the second state timer counts back is similar to a case in which the first state timer counts back.

The first state timer and the second state timer shown above may constitute two embodiments respectively, or may be used in combination in one embodiment to constitute a third embodiment. This application does not limit this. Further, the embodiment illustrated above may be combined with the corresponding embodiments of FIG. 6 and FIG. 8, motion of the virtual vehicle is jointly controlled by combining at least one of the first state timer or the second state timer with the drift threshold, and this application is not limited in this respect.

In an embodiment, such as including but not limited to an embodiment corresponding to the second state timer, there may be no time stamp for performing the second steering operation and the brake operation simultaneously. But it is not excluded that in another embodiment, there is at least one time stamp for simultaneously performing the second steering operation and the brake operation.

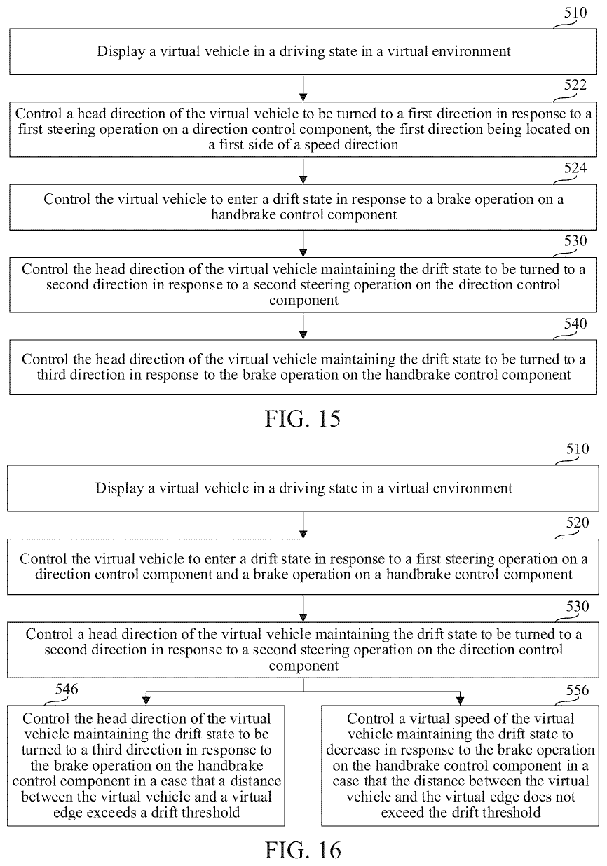

FIG. 14 is a flowchart of a virtual vehicle control method according to an exemplary embodiment of this application. The method may be applied in a terminal supporting a virtual environment. That is, based on the embodiment shown in FIG. 5, operation 554 is further included.

Operation 554: Control a virtual speed of the virtual vehicle to decrease in response to the brake operation on the handbrake control component.

For example, when the virtual vehicle is controlled to enter the drift state, the virtual vehicle is controlled to significantly decrease the virtual speed of the virtual vehicle in a short time through the brake operation on the handbrake control component. For example, the brake operation on the handbrake control component does not directly affect whether the virtual vehicle is in the drift state. Whether or not the virtual vehicle is in the drift state is independent of whether operation 554 is performed. In some embodiments, whether the virtual vehicle is in the drift state is determined by the angle between the head direction of the virtual vehicle and the speed direction of the virtual vehicle.

In some embodiments, in an exemplary implementation, after operation 554, at least one of the following two sub-operations is further included.

Sub-operation 1: Control the virtual vehicle to maintain the drift state when the angle between the head direction of the virtual vehicle and the speed direction of the virtual vehicle exceeds the drift threshold.

For example, an angle is constructed by using the speed direction of the virtual vehicle and the head direction of the virtual vehicle as two sides, and the angle is less than 180 degrees. For example, the drift threshold is configured for determining whether the virtual vehicle is in the drift state; and when the angle between the head direction of the virtual vehicle and the speed direction of the virtual vehicle exceeds the drift threshold, the virtual vehicle maintains the drift state. For example, the drift threshold is 13 degrees.

Sub-operation 2: Control the virtual vehicle to exit the drift state and enter the flat running state when the angle between the head direction of the virtual vehicle and the speed direction of the virtual vehicle does not exceed the drift threshold.

For example, the drift threshold is configured for determining whether the virtual vehicle is in the drift state; and the virtual vehicle exits the drift state and enters the flat running state when the angle between the head direction of the virtual vehicle and the speed direction of the virtual vehicle does not exceed the drift threshold. For example, the drift threshold is 13 degrees.

In conclusion, in the method provided in this embodiment, by performing the brake operation when the virtual vehicle is in the drift state, the virtual vehicle is controlled to decrease the virtual speed, which provides a speed control manner for the virtual vehicle in the drift state. Controlling the virtual vehicle through the brake operation ensures the flexibility of controlling the virtual vehicle in the drift state.

FIG. 15 is a flowchart of a virtual vehicle control method according to an exemplary embodiment of this application, and the method may be applied in a terminal supporting a virtual environment. That is, in the embodiment shown in FIG. 5, operation 520 may be implemented as operation 522 and operation 524.

Operation 522: Control the head direction of the virtual vehicle to be turned to the first direction in response to the first steering operation on the direction control component, the first direction being located on the first side of the speed direction.

The first steering operation is configured for controlling the virtual vehicle to steer to the first side of the speed direction; and the virtual vehicle is controlled to continuously steer to the first direction through the first steering operation on the direction control component.

Operation 524: Control the virtual vehicle to enter the drift state in response to the brake operation on the handbrake control component.

For example, the drift state may also be referred to as a tail flick state, and the virtual vehicle drives sideslip in an over-steer manner in the drift state, to facilitate the virtual vehicle exiting the curve. Through the brake operation on the handbrake control component, the virtual vehicle is controlled to exit the flat running state and enter the drift state, and the virtual vehicle is controlled to drift to the first side In conclusion, in the method provided in this embodiment, by sequentially performing the first steering operation and the brake operation, the virtual vehicle is controlled to perform steering and enter the drift state, which ensures the flexibility of controlling the virtual vehicle and improves the driving capability of the virtual vehicle in the virtual environment.

FIG. 16 is a flowchart of a virtual vehicle control method according to an exemplary embodiment of this application, and the method may be applied in a terminal supporting a virtual environment. That is, in the embodiment shown in FIG. 5, operation 540 may be implemented as operation 546, further including operation 556.

Operation 546: Control the head direction of the virtual vehicle maintaining the drift state to be turned to the third direction in response to the brake operation on the handbrake control component when a distance between the virtual vehicle and a virtual edge exceeds a drift threshold.

The virtual edge is an edge of a virtual road surface in the virtual environment. For example, the edge of the virtual road surface may be an edge lane line on the virtual road surface, or may be an edge of a shoulder on the virtual road surface located on an outer side of the virtual road surface, or may be at least one edge line on which the virtual vehicle cannot continue to drive in an open road surface. This is not limited in this embodiment.

In some embodiments, when the virtual vehicle goes over the virtual edge or touches the virtual edge, the virtual vehicle is in a state disadvantageous for driving. For example, the virtual vehicle is damaged, at least one driving capability of acceleration, steering, or braking of the virtual vehicle is degraded, a virtual economy value is lost, and at least one of a virtual experience value or a virtual task progress is lost.

When a distance between the virtual vehicle and the virtual edge of the virtual road is greater than the drift threshold, the virtual vehicle changes from drifting to the first side to drifting to the second side in response to the brake operation on the handbrake control component. Since the distance between the virtual vehicle and the virtual edge of the virtual road is greater than the drift threshold, there is no risk of the virtual vehicle colliding with or crossing the virtual edge. In operation 546 of this embodiment, in response to the brake operation on the handbrake control component, the virtual speed of the virtual vehicle is generally controlled to decrease. It is not excluded, however, that the virtual speed of the control virtual vehicle is controlled not to change in response to the brake operation on the handbrake control component.

Operation 556: Control a virtual speed of the virtual vehicle maintaining the drift state to decrease in response to the brake operation on the handbrake control component when the distance between the virtual vehicle and the virtual edge is not greater than the drift threshold.

When the distance between the virtual vehicle and the virtual edge of the virtual road is not greater than the drift threshold, the virtual speed of the virtual vehicle decreases in response to the brake operation on the handbrake control component. Since the distance between the virtual vehicle and the virtual edge of the virtual road is not greater than the drift threshold, there is a risk of the virtual vehicle colliding with or crossing the virtual edge. The virtual speed of the virtual vehicle decreases through the brake operation, which delays time for the virtual vehicle to collide with or cross the virtual edge; and Retaining a longer operation time facilitates controlling the driving state of the virtual vehicle, which is advantageous to avoid influencing the driving state of the virtual vehicle. In operation 546 of this embodiment, in response to the brake operation on the handbrake control component, when the virtual speed of the virtual vehicle is controlled to decrease, a first deceleration rate of the virtual speed of the virtual vehicle is less than a second deceleration rate. When the virtual speed of the virtual vehicle is decreasing, the first deceleration rate and the second deceleration rate are each greater than 0.

The first deceleration rate is a rate at which the virtual speed of the virtual vehicle decreases in response to the brake operation on the handbrake control component when the distance between the virtual vehicle and the virtual edge is greater than the drift threshold. The second deceleration rate is a rate at which the virtual speed of the virtual vehicle decreases in response to the brake operation on the handbrake control component when the distance between the virtual vehicle and the virtual edge is not greater than the drift threshold. For example, the first deceleration rate is a 2 m/s drop per second of the virtual speed of the virtual vehicle; and the second deceleration rate is a 5 m/s drop per second of the virtual speed of the virtual vehicle. In a unit time, when the distance between the virtual vehicle and the virtual edge is greater than the drift threshold, a deceleration effect of the virtual vehicle is inferior to a deceleration effect of the virtual vehicle when the distance between the virtual vehicle and the virtual edge is not greater than the drift threshold.

In conclusion, in the method provided in this embodiment, whether there is a driving risk is determined by the distance between the virtual vehicle and the virtual edge; and when there is no driving risk, the virtual vehicle is controlled to change from drifting to the first side to drifting to the second side, which reduces a steering radius when the virtual vehicle passes through a continuous curve, and improves a capability of the virtual vehicle to pass through the continuous curve. When there is a driving risk, the virtual speed of the virtual vehicle is controlled to decrease, which prolongs the time when the virtual vehicle has the driving risk, ensures the driving safety of the virtual vehicle, and avoids damage to the virtual vehicle caused by the driving risk.

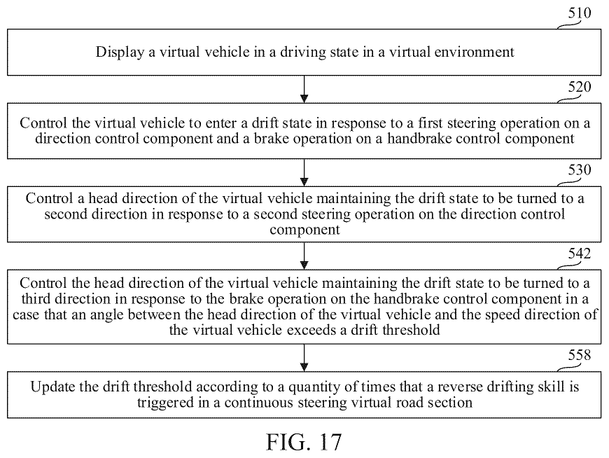

FIG. 17 is a flowchart of a virtual vehicle control method according to an exemplary embodiment of this application. The method may be applied in a terminal supporting a virtual environment. That is, based on the embodiment shown in FIG. 6, operation 558 is further included.

Operation 558: Update the drift threshold according to a quantity of times that the reverse drift skill is triggered in a continuous steering virtual road section.

For example, the continuous steering virtual road section is a road section at which there are at least two direction change points on the virtual road in the virtual environment. In an example, when the virtual vehicle is driven to pass through the continuous steering virtual road section, the virtual vehicle needs to be controlled to first steer to the first side of the speed direction of the virtual vehicle and then to the second side of the speed direction, avoiding collision of the virtual vehicle with an edge of the virtual road surface. Further, the quantity of times that the reverse drift skill is triggered in the continuous steering virtual road section indicates a preference for the reverse drift skill as the player is passing through the continuous steering virtual road section. When the quantity of times that the reverse drift skill is triggered is high, it indicates that the player prefers to trigger the reverse drift skill to pass through the continuous steering virtual road section. When the quantity of times that the reverse drift skill is triggered is low, it indicates that the player prefers to steer or enter the drift state a plurality of times to pass through the continuous steering virtual road section. For example, the reverse drift skill instructs the virtual vehicle maintaining the drift state to change from drifting to the first side to drifting to the second side.

In some embodiments, in an implementation, operation 558 may be implemented as the following two sub-operations.

Sub-operation 3: Update the drift threshold to a first angle threshold when the quantity of times that the reverse drift skill is triggered in the continuous steering virtual road section is greater than a quantity-of-times threshold, the first angle threshold being less than the drift threshold.

For example, when the quantity of times that the reverse drift skill is triggered is greater than the quantity-of-times threshold, it indicates that the virtual vehicle prefers to trigger the reverse drift skill when passing through the continuous steering virtual road section. By updating the drift threshold to the first angle threshold, time during which the virtual vehicle maintains the drift state increases, facilitating the player to perform the brake operation when the virtual vehicle maintains the drift state and controlling the head direction of the virtual vehicle to be turned to the third direction to trigger the reverse drift skill.

Sub-operation 4: Update the drift threshold to a second angle threshold when the quantity of times that the reverse drift skill is triggered in the continuous steering virtual road section is not greater than the quantity-of-times threshold, the second angle threshold being greater than the drift threshold.

For example, when the quantity of times that the reverse drift skill is triggered is not greater than the quantity-of-times threshold, it indicates that the virtual vehicle prefers to steer or enter the drift state a plurality of times when passing through the continuous steering virtual road section. By updating the drift threshold to the second angle threshold, the time during which the virtual vehicle maintains the drift state is reduced, facilitating the virtual vehicle to exit the drift state as soon as possible to pass through the continuous steering virtual road section by steering or entering the drift state again. In conclusion, in the method provided in this embodiment, passing preference of the virtual vehicle in the continuous steering virtual road section is determined through the quantity-of-times threshold. When triggering of the reverse drift skill is preferred for passing through the continuous steering virtual road section, a strict exit drift state condition is set, the time during which the virtual vehicle maintains the drift state increases, and an advantageous condition for increasing the time is provided for triggering the reverse drift skill; and when steering or entering the drift state a plurality of times is preferred for passing through the continuous steering virtual road section, a relaxed exit drift state condition is set, and the time during which the virtual vehicle maintains the drift state decreases, which is conducive to quickly exiting the drift state to perform turning or enter the drift state a plurality of times.

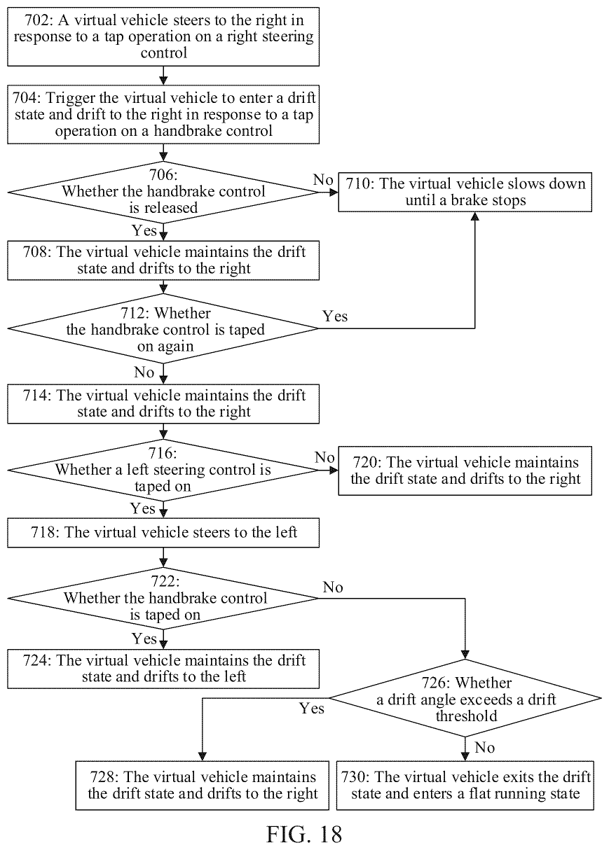

FIG. 18 is a flowchart of a virtual vehicle control method according to an exemplary embodiment of this application. The virtual vehicle control method includes the following operations.

Operation 702: A virtual vehicle steers to the right in response to a tap operation on a right steering control.

For example, in response to the tap operation on the right steering control, the head direction of the virtual vehicle is steered to the right.

Operation 704: Trigger the virtual vehicle to enter a drift state and drift to the right in response to a tap operation on a handbrake control.

In response to the tap operation on the handbrake control, the driving speed of the virtual vehicle rapidly decreases. For example, since an angle between the head direction of the virtual vehicle and the speed direction of the virtual vehicle exceeds a drift threshold, the virtual vehicle enters the drift state; and since the head direction of the virtual vehicle is toward the right, the virtual vehicle drifts to the right.

Operation 706: Whether the handbrake control is released. For example, the handbrake control is released, that is, the handbrake control is not continuously pressed.

Operation 708: The virtual vehicle maintains the drift state and drifts to the right. When the handbrake control is released, the virtual vehicle maintains the drift state and drifts to the right; and the virtual vehicle is not affected by the handbrake control and does not rapidly reduce the driving speed.

Operation 710: The virtual vehicle slows down until a brake stops. When the handbrake control is not released, the virtual vehicle slows down until the brake stops; and the virtual vehicle is continuously affected by the handbrake control and rapidly reduces the driving speed until the virtual vehicle brakes and stops.

Operation 712: Whether the handbrake control is taped on again.

Operation 714: The virtual vehicle maintains the drift state and drifts to the right.

When the handbrake control is not taped on again, the virtual vehicle maintains the drift state and drifts to the right; and the virtual vehicle is not affected by the handbrake control and does not rapidly reduce the driving speed. When the handbrake control is taped on again, operation 710 is performed and the virtual vehicle slows down until the brake stops.

Operation 716: Whether a left steering control is taped on.

For example, in response to a tap operation on the left steering control, the head direction of the virtual vehicle steers to the left.

Operation 718: The virtual vehicle steers to the left. When the left steering control is taped on, the head direction of the virtual vehicle steers to the left. For example, the virtual vehicle maintains the drift state.

Operation 720: The virtual vehicle maintains the drift state and drifts to the right.

When the left steering control is not taped on, the virtual vehicle maintains the drift state and drifts to the right; and the virtual vehicle is not affected by the left steering control, and the head direction of the virtual vehicle is not affected by the left steering control to steer to the left.

Operation 722: Whether the handbrake control is taped on.

In response to a tap operation on the handbrake control, the driving speed of the virtual vehicle rapidly decreases.

Operation 724: The virtual vehicle maintains the drift state and drifts to the left. When the handbrake control is taped on, the virtual vehicle maintains the drift state and drifts to the left; and the head direction of the virtual vehicle changes from pointing to the right to pointing to the left and drifts to the left.

Operation 726: Whether a drifting angle exceeds a drift threshold. When the handbrake control is not taped on, whether the drifting angle exceeds the drift threshold is determined. The drifting angle is an angle between the head direction of the virtual vehicle and the speed direction of the virtual vehicle.

Operation 728: The virtual vehicle maintains the drift state and drifts to the right.

When the drifting angle exceeds the drift threshold, the virtual vehicle maintains the drift state and drifts to the right.

Operation 730: The virtual vehicle exits the drift state and enters a flat running state.

When the drifting angle does not exceed the drift threshold, the virtual vehicle exits the drift state and enters the flat running state.

For example, the virtual vehicle in this application may be a virtual vehicle implemented by simulating driving characteristics of a car in the real world, and the virtual vehicle is not limited in appearance. For example, a virtual driving machine drives on a virtual cloud in a virtual environment. Even if an appearance of the driving machine has appearance characteristics of a virtual wing, the driving machine conforms to the driving characteristics of the car and drives on the virtual cloud without relying on lift or simulated lift for changing a pitch angle. Therefore, the driving machine is to be within the scope of the virtual vehicle shown in this application. Further, this application does not limit a control manner of the virtual vehicle, and the virtual vehicle can be controlled through a keyboard, a mouse, or a handle, or by simulating a steering wheel or a pedal for vehicle driving. This is not limited in this application. The virtual vehicle control method may be applied in a virtual vehicle racing application program, or may be applied in a virtual vehicle simulation driving application program, or may be applied in another application program having a vehicle racing function or a vehicle simulation driving function.

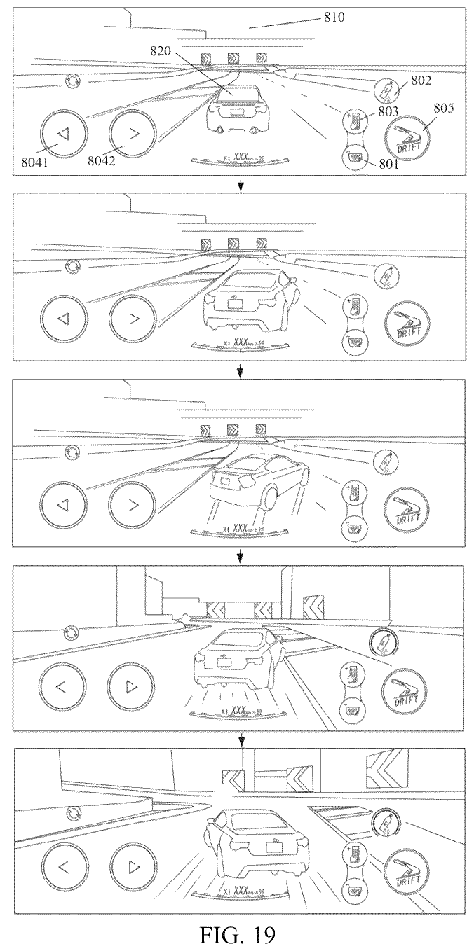

FIG. 19 is a schematic diagram of an interface of a virtual vehicle control method according to an exemplary embodiment of this application. A brake control component, an energy control component, and an accelerator control component may be displayed in a form of a control in a display interface 810. A brake control 801, an energy control 802, an accelerator control 803, a left turn control 8041, a right turn control 8042, and a handbrake control 805 are displayed in the display interface 810.

A virtual vehicle 820 in a driving state in a virtual environment is displayed; the virtual vehicle 820 drives forward, and a speed direction of the virtual vehicle is the same as a head direction of the virtual vehicle;

the head direction of the virtual vehicle 820 is controlled to be turned to a right side in response to a click operation on the right turn control 8042; the head direction is located on the right side of the speed direction in response to the click operation on the right turn control 8042; and the click operation on the right turn control 8042 is configured for controlling the virtual vehicle 820 to be turned to the right side of the speed direction. For example, since the virtual vehicle 820 is in a flat running state, no virtual trace caused by tire friction is displayed in the virtual road.

In response to a brake operation on the handbrake control 805, the virtual vehicle is controlled to enter a drift state, and the head direction of the virtual vehicle is a first direction. For example, the drift state may also be referred to as a tail flick state, and the virtual vehicle drives sideslip in an over-steer manner in the drift state, to facilitate the virtual vehicle exiting the curve. Through the brake operation on the handbrake control 805, the virtual vehicle is controlled to exit the flat running state and enter the drift state, and the virtual vehicle is controlled to drift to the right side.

The head direction of the virtual vehicle maintaining the drift state is controlled to be turned to a second direction in response to a click operation on the left turn control 8041; a second angle formed between the second direction and the speed direction is less than a first angle formed between the first direction and the speed direction; and the virtual vehicle maintains the drift state and drifts to the right side.

In response to the brake operation on the handbrake control 805, the head direction of the virtual vehicle maintaining the drift state is controlled to be turned to a third direction; and the third direction is located on a left side of the speed direction. For example, the virtual vehicle changes from drifting to the right side to drifting to the left side. In some embodiments, release information of a reverse drift skill is displayed; and the reverse drift skill is configured for instructing the virtual vehicle to change from drifting to the right side to drifting to the left side, or the virtual vehicle to change from drifting to the left side to drifting to the right side. The release information of the reverse drift skill may be at least one of text information, a highlight special effect, a flash special effect, an aperture special effect, or a sound special effect.

Further, after the release information of the reverse drift skill is displayed, that is, the virtual vehicle changes from drifting to the right side to drifting to the left side, engaging the driving skill through a control operation on the virtual vehicle. For example, an ejection bend skill is triggered in response to a trigger operation on the energy control 802, and the driving speed of the virtual vehicle increases.

A grip force of the virtual vehicle increases in response to a click operation on the brake control 801; in response to the trigger operation on the energy control 802, consuming a bottle of nitrogen provides the acceleration service for the virtual vehicle 820, and prompt information for consuming the bottle of nitrogen may be displayed in the display interface 810; and a pressurized nitrogen bleed skill is triggered.

For example, the brake control 801 is further configured to implement at least one of a stop acceleration function, a deceleration function, or a reverse function of the virtual vehicle. For example, after the virtual vehicle enters a continuous acceleration state, in response to a single tap operation on the brake control 801, the virtual vehicle is controlled to stop acceleration and enter a natural deceleration state. The natural deceleration state is a continuous deceleration state that the virtual vehicle enters by a resistance factor, and the resistance factor includes at least one of road surface resistance, air resistance, or mechanical loss. For another example, in response to a continuous pressing operation on the brake control 801, the virtual vehicle is controlled to stop acceleration and enter a continuous deceleration state. The continuous deceleration state is a reservoir deceleration state that the virtual vehicle enters by a resistance factor and brake braking resistance, the resistance factor includes at least one of road surface resistance, air resistance, or mechanical loss, and the brake braking resistance is generated according to the continuous pressing operation on the brake control 801.

The road surface resistance is a friction force between tires of the virtual vehicle and the ground, the air resistance is air resistance experienced by the virtual vehicle during running, the mechanical loss is kinetic energy loss in a transmission apparatus of the virtual vehicle, and a magnitude of the brake braking resistance may be set according to actual requirements. In some embodiments, when the virtual vehicle is in the continuous deceleration state, if the vehicle speed of the virtual vehicle decreases to 0 and a continuous pressing on the brake control 801 still exists, the virtual vehicle is controlled to enter a reverse state. For example, the handbrake control 805 is similar to the brake control 801 and is further configured to implement at least one of the stop acceleration function, the deceleration function, or the reverse function of the virtual vehicle. Speed control, in particular deceleration control, of the virtual vehicle is achieved through the handbrake control 805 and the brake control 801, which is close to the driving principles in the real world.

A person of ordinary skill in the art can understand that the foregoing embodiments can be independently implemented, and the foregoing embodiments can also be freely combined to combine new embodiments to implement the virtual vehicle control method of this application.

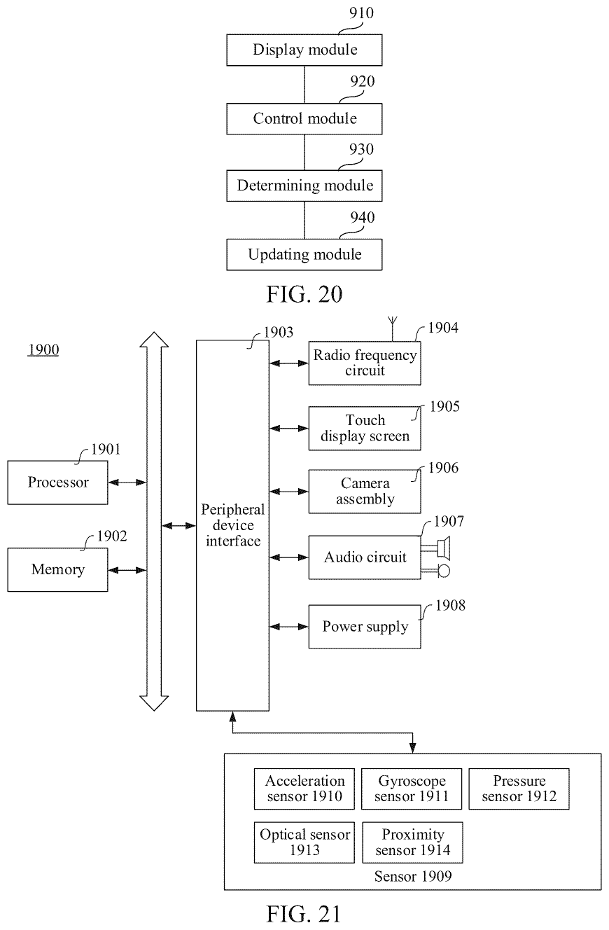

FIG. 20 is a block diagram of a virtual vehicle control apparatus according to an exemplary embodiment of this application. The apparatus includes:
a display module 910, configured to perform operation 510 in the embodiment of FIG. 5;
a control module 920, configured to perform operation 520 in the embodiment of FIG. 5;
the control module 920 being further configured to perform operation 530 in the embodiment of FIG. 5; and
the control module 920 being further configured to perform operation 540 in the embodiment of FIG. 5.

In an exemplary design of this application, the control module 920 is further configured to perform operation 542 in the embodiment of FIG. 6.

In an exemplary design of this application, the control module 920 is further configured to: control the head direction of the virtual vehicle maintaining the drift state to be turned to the third direction and display release information of a reverse drift skill in response to the brake operation on the handbrake control component when the angle between the head direction of the virtual vehicle and the speed direction of the virtual vehicle exceeds the drift threshold.

In an exemplary design of this application, the control module 920 is further configured to perform operation 552 in the embodiment of FIG. 8.

In an exemplary design of this application, the apparatus further includes:
a determining module 930, configured to perform operation 535 in the embodiment of FIG. 11.

In an exemplary design of this application, the second steering operation is a continuous pressing operation on the direction control component; and the control module 920 is further configured to perform operation 544 in the embodiment of FIG. 13.

In an exemplary design of this application, the control module 920 is further configured to perform operation 522 and operation 524 in the embodiment of FIG. 15.

In an exemplary design of this application, the control module 920 is further configured to perform operation 554 in the embodiment of FIG. 14.

In an exemplary design of this application, the control module 920 is further configured to: control the virtual vehicle to maintain the drift state when the angle between the head direction of the virtual vehicle and the speed direction of the virtual vehicle exceeds the drift threshold; and control the virtual vehicle to exit the drift state and enter the flat running state when the angle between the head direction of the virtual vehicle and the speed direction of the virtual vehicle does not exceed the drift threshold.

In an exemplary design of this application, the control module 920 is further configured to perform operation 546 and operation 556 in the embodiment of FIG. 16.

In an exemplary design of this application, the apparatus further includes: an updating module 940, configured to update the drift threshold according to a quantity of times that the reverse drift skill is triggered in a continuous steering virtual road section.

In an exemplary design of this application, the updating module 940 is further configured to:
update the drift threshold to a first angle threshold when the quantity of times that the reverse drift skill is triggered in the continuous steering virtual road section is greater than a quantity-of-times threshold, the first angle threshold being less than the drift threshold; and
update the drift threshold to a second angle threshold when the quantity of times that the reverse drift skill is triggered in the continuous steering virtual road section is not greater than the quantity-of-times threshold, the second angle threshold being greater than the drift threshold.

When the apparatus provided in the foregoing embodiments implements functions of the apparatus, it is illustrated with an example of division of each functional module. In the practical application, the function distribution may be finished by different functional modules according to actual requirements, that is, the internal structure of the device is divided into different functional modules, to implement all or some of the functions described above.

Specific manners of performing operations by the modules of the apparatus in the foregoing embodiment are already described in detail in the embodiments related to the method. The technical effects achieved by each modules performing the operations are the same as those in the embodiments related to the method, which will not be described in detail herein.

The embodiments of this application further provide a computer device. The computer device includes: a processor and a memory, the memory having a computer program stored therein; and the processor being configured to execute the computer program in the memory to implement the virtual vehicle control method provided in the foregoing method embodiments.

FIG. 21 is a structural block diagram of a terminal 1900 according to an exemplary embodiment of this application. The terminal 1900 may be: a smartphone, a tablet computer, a moving picture experts group audio layer III (MP3) player, a moving picture experts group audio layer IV (MP4) player, a notebook computer, or a desktop computer. The terminal 1900 may also be referred to by other names as a user equipment, a portable terminal, a laptop terminal, a desktop terminal, or the like.

Generally, the terminal 1900 includes: a processor 1901 and a memory 1902. The processor 1901 may include one or more processing cores, such as a 4-core processor or an 8-core processor. The processor 1901 may be implemented by at least one hardware form in a digital signal processing (DSP), a field-programmable gate array (FPGA), and a programmable logic array (PLA). The processor 1901 includes a main processor and a coprocessor. The main processor is configured to process data in an active state, also referred to as a central processing unit (CPU). The coprocessor is a low-power consumption processor configured to process data in a standby state. In some embodiments, the processor 1901 may be integrated with a graphics processing unit (GPU). The GPU is configured to be responsible for rendering and drawing content that needs to be displayed in a display. In some embodiments, the processor 1901 may further include an artificial intelligence (Artificial Intelligence, AI) processor. The AI processor is configured to process computing operations related to machine learning.

The memory 1902 may include one or more computer-readable storage media. The computer-readable storage media may be non-transitory. The memory 1902 may further include a high-speed random access memory, as well as non-volatile memory, such as one or more disk storage devices and flash storage devices. In some embodiments, the non-transient computer-readable storage medium in the memory 1902 is configured to store at least one instruction. The at least one instruction is executed by the processor 1901 to implement the virtual vehicle control method provided in the method embodiments in this application.

In some embodiments, the terminal 1900 may further include: a peripheral device interface 1903 and at least one peripheral device. The processor 1901, the memory 1902, and the peripheral device interface 1903 may be connected by using a bus or a signal cable. Each peripheral device may be connected to the peripheral device interface 1903 through a bus, a signal cable, or a circuit board. Specifically, the peripheral device includes: at least one of a radio frequency circuit 1904, a touch display screen 1905, a camera assembly 1906, an audio circuit 1907, and a power supply 1908. The peripheral interface 1903 may be configured to connect at least one peripheral device related to input/output (I/O) to the processor 1901 and the memory 1902. In some embodiments, the processor 1901, the memory 1902, and the peripheral device interface 1903 are integrated on the same chip or the same circuit board. In some other embodiments, any or both of the processor 1901, the memory 1902, and the peripheral device interface 1903 may be implemented on an independent chip or circuit board. This is not limited in this embodiment. The radio frequency circuit 1904 is configured to receive and transmit a radio frequency (RF) signal, also referred to as an electromagnetic signal. The radio frequency circuit 1904 communicates with a communication network and other communication devices through the electromagnetic signal. The radio frequency circuit 1904 may further include a circuit related to near field communication (NFC). The touch display screen 1905 is configured to display a user interface (UI). The UI may include a graph, a text, an icon, a video, and any combination thereof. The camera assembly 1906 is configured to collect images or videos. In some embodiments, the camera assembly 1906 includes a front-facing camera and a rear-facing camera. The audio frequency circuit 1907 may include a microphone and a speaker. The microphone is configured to collect sound waves from a user and an environment and convert the sound waves into electrical signals that are inputted to the processor 1901 for processing or to the radio frequency circuit 1904 for voice communication. The power supply 1908 is configured to supply power to components in the terminal 1900. The power supply 1908 may be an alternating current, a direct current, a disposable battery, or a rechargeable battery. In some embodiments, the terminal 1900 further includes one or more sensors 1909. The one or more sensors 1909 include but are not limited to an acceleration sensor 1910, a gyro sensor 1911, a pressure sensor 1912, an optical sensor 1913, and a proximity sensor 1914.

The acceleration sensor 1910 may detect the magnitude of acceleration on three coordinate axes of a coordinate system established with the terminal 1900. The pressure sensor 1912 may be disposed on a side frame of the terminal 1900 and/or a lower layer of the display screen 1905. A holding signal of the terminal 1900 by the user is detected, and/or the operability control on the UI interface is controlled according to a pressure operation by the user on the touch display screen 1905. The optical sensor 1913 is configured to collect ambient light intensity. The proximity sensor 1914, also referred to as a distance sensor, is generally disposed on the front panel of the terminal 1900. The proximity sensor 1914 is configured to collect a distance between the user and a front surface of the terminal 1900. A person skilled in the art can understand that the foregoing structure does not constitute a limitation to the terminal 1900, and the terminal may include more or fewer components than those shown in the figure, or some components may be combined, or a different component arrangement may be used.

In an exemplary embodiment, a chip is further provided. The chip includes a programmable logic circuit and/or program instructions, and when running on a computer device, the chip is configured to implement the virtual vehicle control method in the foregoing aspect.

In an exemplary embodiment, a computer program product is further provided. The computer program product includes computer instructions, and the computer instructions are stored in a non-transitory computer-readable storage medium. A processor of a computer device reads the computer instructions from the computer-readable storage medium, and the processor reads and executes the computer instructions from the computer-readable storage medium to implement the virtual vehicle control method in the foregoing method embodiments.

In an exemplary embodiment, a non-transitory computer-readable storage medium is further provided, the computer-readable storage medium having a computer program stored therein, and the at least one computer program being loaded and executed by a processor to implement the virtual vehicle control method provided in the foregoing method embodiments. A person of ordinary skill in the art may understand that all or some of the operations of the foregoing embodiments may be implemented by using hardware, or may be implemented by a program instructing relevant hardware. The program may be stored in a computer-readable storage medium. The storage medium may be a ROM, a magnetic disk, an optical disc, or the like. A person skilled in the art should be aware that in the one or more examples, the functions described in the embodiments of this application may be implemented by using hardware, software, firmware, or any combination thereof. When implemented by using software, the functions can be stored in a computer-readable medium or can be used as one or more instructions or code in a computer-readable medium for transmission. The computer-readable medium includes a computer storage medium and a communication medium, where the communication medium includes any medium that enables a computer program to be transmitted from one place to another. The storage medium may be any available medium accessible to a general-purpose or dedicated computer.

What is claimed is:

1. A virtual vehicle control method performed by a computer device, the method comprising:
displaying a virtual vehicle in a driving state in a virtual environment;
controlling the virtual vehicle to enter a drift state in response to a first steering operation on a direction control component and a brake operation on a handbrake control component, the first steering operation being configured for controlling the virtual vehicle to steer to a first side of a speed direction;
turning the head direction of the virtual vehicle from a first direction to a second direction in response to a second steering operation on the direction control component, the second steering operation being configured for controlling the virtual vehicle to steer to a second side of the speed direction, and a second angle formed between the second direction and the speed direction being less than a first angle formed between the first direction and the speed direction; and
turning the head direction of the virtual vehicle from the second direction to a third direction in response to the brake operation on the handbrake control component, the third direction being located on the second side of the speed direction.

2. The method according to claim 1, wherein the turning the head direction of the virtual vehicle from the second direction to a third direction in response to the brake operation on the handbrake control component comprises:
turning the head direction of the virtual vehicle from the second direction to the third direction in response to the brake operation on the handbrake control component when an angle between the head direction of the virtual vehicle and the speed direction of the virtual vehicle exceeds a drift threshold.

3. The method according to claim 2, wherein the method further comprises:
controlling the virtual vehicle to exit the drift state and enter a flat running state when the angle between the head direction of the virtual vehicle and the speed direction of the virtual vehicle does not exceed the drift threshold.

4. The method according to claim 2, wherein the method further comprises:
determining the speed direction of the virtual vehicle according to a grip force of the virtual vehicle, the head direction of the virtual vehicle, and a historical speed direction of the virtual vehicle.

5. The method according to claim 2, wherein the method further comprises:
updating the drift threshold according to a quantity of times that the reverse drift skill is triggered in a continuous steering virtual road section.

6. The method according to claim 1, wherein the second steering operation is a continuous pressing operation on the direction control component; and
the turning the head direction of the virtual vehicle from the second direction to the third direction in response to the brake operation on the handbrake control component comprises:
turning the head direction of the virtual vehicle from the second direction to the third direction in response to the continuous pressing operation on the direction control component and the brake operation on the handbrake control component.

7. The method according to claim 1, wherein the controlling the virtual vehicle to enter a drift state in response to a first steering operation on a direction control component and a brake operation on a handbrake control component comprises:
turning the head direction of the virtual vehicle to the first direction in response to the first steering operation on the direction control component, wherein the first direction is located on the first side of the speed direction; and
controlling the virtual vehicle to enter the drift state in response to the brake operation on the handbrake control component.

8. The method according to claim 1, wherein the method further comprises:
controlling a virtual speed of the virtual vehicle to decrease in response to the brake operation on the handbrake control component.

9. The method according to claim 1, wherein the turning the head direction of the virtual vehicle from the second direction to a third direction in response to the brake operation on the handbrake control component comprises:
turning the head direction of the virtual vehicle from the second direction to the third direction in response to the brake operation on the handbrake control component when a distance between the virtual vehicle and a virtual edge exceeds a drift threshold, wherein the virtual edge is an edge of a virtual road surface in the virtual environment; and
decreasing a virtual speed of the virtual vehicle in response to the brake operation on the handbrake control component when the distance between the virtual vehicle and the virtual edge does not exceed the drift threshold.

10. A computer device, comprising: a processor and a memory, the memory having at least one program stored therein; and the processor being configured to execute the at least one program in the memory to perform a virtual vehicle control method including:
displaying a virtual vehicle in a driving state in a virtual environment;
controlling the virtual vehicle to enter a drift state in response to a first steering operation on a direction control component and a brake operation on a handbrake control component, the first steering operation being configured for controlling the virtual vehicle to steer to a first side of a speed direction;
turning the head direction of the virtual vehicle from a first direction to a second direction in response to a second steering operation on the direction control component, the second steering operation being configured for controlling the virtual vehicle to steer to a second side of the speed direction, and a second angle formed between the second direction and the speed direction being less than a first angle formed between the first direction and the speed direction; and
turning the head direction of the virtual vehicle from the second direction to a third direction in response to the brake operation on the handbrake control component, the third direction being located on the second side of the speed direction.

11. The computer device according to claim 10, wherein the turning the head direction of the virtual vehicle from the second direction to a third direction in response to the brake operation on the handbrake control component comprises:
turning the head direction of the virtual vehicle from the second direction to the third direction in response to the brake operation on the handbrake control component when an angle between the head direction of the virtual vehicle and the speed direction of the virtual vehicle exceeds a drift threshold.

12. The computer device according to claim 11, wherein the method further comprises:
controlling the virtual vehicle to exit the drift state and enter a flat running state when the angle between the head direction of the virtual vehicle and the speed direction of the virtual vehicle does not exceed the drift threshold.

13. The computer device according to claim 11, wherein the method further comprises:
determining the speed direction of the virtual vehicle according to a grip force of the virtual vehicle, the head direction of the virtual vehicle, and a historical speed direction of the virtual vehicle.

14. The computer device according to claim 11, wherein the method further comprises:
updating the drift threshold according to a quantity of times that the reverse drift skill is triggered in a continuous steering virtual road section.

15. The computer device according to claim 10, wherein the second steering operation is a continuous pressing operation on the direction control component; and
the turning the head direction of the virtual vehicle from the second direction to the third direction in response to the brake operation on the handbrake control component comprises:
turning the head direction of the virtual vehicle from the second direction to the third direction in response to the continuous pressing operation on the direction control component and the brake operation on the handbrake control component.

16. The computer device according to claim 10, wherein the controlling the virtual vehicle to enter a drift state in response to a first steering operation on a direction control component and a brake operation on a handbrake control component comprises:
turning the head direction of the virtual vehicle to the first direction in response to the first steering operation on the direction control component, wherein the first direction is located on the first side of the speed direction; and
controlling the virtual vehicle to enter the drift state in response to the brake operation on the handbrake control component.

17. The computer device according to claim 10, wherein the method further comprises:
controlling a virtual speed of the virtual vehicle to decrease in response to the brake operation on the handbrake control component.

18. The computer device according to claim 10, wherein the turning the head direction of the virtual vehicle from the second direction to a third direction in response to the brake operation on the handbrake control component comprises:
turning the head direction of the virtual vehicle from the second direction to the third direction in response to the brake operation on the handbrake control component when a distance between the virtual vehicle and a virtual edge exceeds a drift threshold, wherein the virtual edge is an edge of a virtual road surface in the virtual environment; and
decreasing a virtual speed of the virtual vehicle in response to the brake operation on the handbrake control component when the distance between the virtual vehicle and the virtual edge does not exceed the drift threshold.

19. A non-transitory computer-readable storage medium, storing executable instructions stored therein, the executable instructions being loaded and executed by a processor of a computer device to perform a virtual vehicle control method including:
displaying a virtual vehicle in a driving state in a virtual environment;
controlling the virtual vehicle to enter a drift state in response to a first steering operation on a direction control component and a brake operation on a handbrake control component, the first steering operation being configured for controlling the virtual vehicle to steer to a first side of a speed direction;
turning the head direction of the virtual vehicle from a first direction to a second direction in response to a second steering operation on the direction control component, the second steering operation being configured for controlling the virtual vehicle to steer to a second side of the speed direction, and a second angle formed between the second direction and the speed direction being less than a first angle formed between the first direction and the speed direction; and
turning the head direction of the virtual vehicle from the second direction to a third direction in response to the brake operation on the handbrake control component, the third direction being located on the second side of the speed direction.

20. The non-transitory computer-readable storage medium according to claim 19, wherein the method further comprises:
controlling the virtual vehicle to exit the drift state and enter a flat running state when the angle between the head direction of the virtual vehicle and the speed direction of the virtual vehicle does not exceed the drift threshold.
